(19) United States
(12) Patent Application Publication
(10) Pub. No.: US 2026/0312707 A1
(43) Pub. Date: Oct. 8, 2026

(54) ELECTRONIC DEVICE AND METHOD FOR SPECTRUM MANAGEMENT APPARATUS

(71) Applicant: SONY GROUP CORPORATION, TOKYO (JP)

(72) Inventors: SHUO WANG, TOKYO (JP); CHEN SUN, TOKYO (JP)

(21) Appl. No.: 19/480,904

(22) PCT Filed: May 6, 2024
(86) PCT No.: PCT/CN2024/091108

§ 371 Date: Nov. 3, 2025

(30) Foreign Application Priority Data
May 9, 2023 (CN) 202310519954.2

(51) Int. Cl. H04B 17/391; H04B 17/382

(52) U.S. Cl. CPC H04B 17/3913; H04B 17/382

(57) ABSTRACT

The present application relates to an electronic device and method for a spectrum management apparatus. The electronic device for the spectrum management apparatus comprises a processing circuit. The processing circuit is configured to, with respect to at least one federated prediction area in a plurality of federated prediction areas constructed based on a secondary system, obtain a primary system behavior model configured for predicting the behavior of a primary system using spectrum resources by means of federated learning.

This application claims priority to Chinese Patent Application No. 202310519954.2 titled “ELECTRONIC DEVICE AND METHOD FOR SPECTRUM MANAGEMENT APPARATUS”, filed on May 9, 2023 with the China National Intellectual Property Administration (CNIPA), which is incorporated herein by reference in its entirety.

### FIELD

The present disclosure relates to the technical field of wireless communications, and particularly to an electronic apparatus and a method for a spectrum management device. More specifically, the present disclosure relates to effective prediction on a received power of a primary system in different regions for spectrum resource sensing.

### BACKGROUND

In existing spectrum sharing technologies, occupancy of available spectrum resources is predicted based on federated learning. In large-scale network scenarios, global federated learning may lead to problems of high communication latency and high model complexity.

### SUMMARY

A brief summary of the present disclosure is given below, to provide a basic understanding of some aspects of the present disclosure. It should be understood that the following summary is not an exhaustive summary of the present disclosure. It is not intended to determine a key or important part of the present disclosure, nor does it intend to limit the scope of the present disclosure. The purpose is merely to present some concepts in a simplified form, as a preamble to a more detailed description discussed later.

According to an aspect of the present disclosure, an electronic apparatus for a spectrum management device is provided. The electronic apparatus includes processing circuitry, configured to: obtain a primary system behavior model for predicting a behavior of a primary system making use of spectrum resources, through federated learning for at least one of multiple federated prediction regions constructed based on secondary systems.

In the embodiments of the present disclosure, a received power of a primary system in different regions can be effectively predicted for spectrum resource sensing.

According to an aspect of the present disclosure, an electronic apparatus for a spectrum management device is provided. The electronic apparatus includes processing circuitry, configured to: assist in obtaining a primary system behavior model for predicting a behavior of a primary system making use of spectrum resources, through federated learning for one of multiple federated prediction regions constructed based on secondary systems.

In the embodiments of the present disclosure, assistance is performed to effectively predict a received power of a primary system in different regions for spectrum resource sensing.

According to an aspect of the present disclosure, a method for a spectrum management device is provided. The method includes: causing the spectrum management device to obtain a primary system behavior model for predicting a behavior of a primary system making use of spectrum resources, through federated learning for at least one of multiple federated prediction regions constructed based on secondary systems.

According to an aspect of the present disclosure, a method for a spectrum management device is provided. The method includes: assisting in obtaining a primary system behavior model for predicting a behavior of a primary system making use of spectrum resources, through federated learning for one of multiple federated prediction regions constructed based on secondary systems.

According to other aspects of the present disclosure, computer program codes and a computer program product for implementing the above-described method for a spectrum management device and a computer-readable storage medium having the computer program codes for implementing the method for a spectrum management device stored thereon are further provided.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for a spectrum management device according to an embodiment of the present disclosure;

FIG. 2(a) illustrates an example of a system structure according to an embodiment of the present disclosure, and FIG. 2(b) illustrates another example of a system structure according to an embodiment of the present disclosure;

FIG. 3 illustrates an example of dividing a network according to an embodiment of the present disclosure;

FIG. 4 illustrates an example of a pseudo code of a K-DBSCAN algorithm according to an embodiment of the present disclosure;

FIG. 5(a) and FIG. 5(b) illustrate examples of an effect of determining federated prediction regions through a K-DBSCAN algorithm according to an embodiment of the present disclosure;

FIG. 6 illustrates an example of a process for constructing a federated prediction region according to an embodiment of the present disclosure;

FIG. 7 is a schematic diagram showing information interaction for constructing a federated learning group according to an embodiment of the present disclosure;

FIG. 8 illustrates an example of selecting a federated aggregation point for local model aggregation according to an embodiment of the present disclosure;

FIG. 9 illustrates is an example of a structure of an LSTM network model according to an embodiment of the present disclosure;

FIG. 10 is an example flow chart of obtaining a primary system behavior model through federated learning based on a federated prediction region according to an embodiment of the present disclosure;

FIG. 11(a) shows an actual received power of a primary system and a predicted received power of the primary system predicted through a conventional technology, FIG. 11(b) shows an actual received power of a primary system and a predicted received power of the primary system predicted with quantity weighted aggregation, and FIG. 11(c) shows an error of a predicted received power of a primary system predicted through a conventional technology and an error of a predicted received power of the primary system predicted with quantity weighted aggregation;

FIG. 12 shows a block diagram of functional modules of an electronic apparatus for a spectrum management device according to another embodiment of the present disclosure;

FIG. 13 shows a flow chart of a method for a spectrum management device according to an embodiment of the present disclosure;

FIG. 14 shows a flow chart of a method for a spectrum management device according to another embodiment of the present disclosure;

FIG. 15 is a block diagram showing a first example of a schematic configuration of an eNB or gNB to which the technology of the present disclosure is applicable;

FIG. 16 is a block diagram showing a second example of a schematic configuration of an eNB or gNB to which the technology of the present disclosure is applicable;

FIG. 17 is a block diagram showing an example of a schematic configuration of a smart phone to which the technology of the present disclosure is applicable;

FIG. 18 is a block diagram showing an example of a schematic configuration of an automobile navigation device to which the technology of the present disclosure is applicable; and

FIG. 19 is a block diagram of an exemplary structure of a universal personal computer in which the methods and/or apparatuses and/or systems according to the embodiments of the present disclosure is applicable.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made while implementing any of such actual embodiments so as to achieve specific objectives of a developer, for example, to comply with system- and business-related constraining conditions which vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

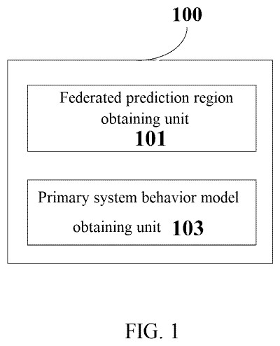

FIG. 1 shows a block diagram of functional modules of an electronic apparatus 100 for a spectrum management device according to an embodiment of the present disclosure. The electronic apparatus 100 may serve as a spectrum management device.

As shown in FIG. 1, the electronic apparatus 100 includes a federated prediction region obtaining unit 101 and a primary system behavior model obtaining unit 103. The federated prediction region obtaining unit 101 may be configured to obtain at least one federated prediction region among multiple federated prediction regions constructed based on a secondary system (also referred to as a secondary user or SU). The primary system behavior model obtaining unit 103 may be configured to obtain a primary system behavior model (hereinafter sometimes referred to as a global model) for predicting a behavior of a primary system (also referred to as a primary user or PU) making use of spectrum resources. The primary system behavior model is obtained through federated learning.

The federated prediction region obtaining unit 101 and the primary system behavior model obtaining unit 103 may be implemented by one or more processing circuits. The processing circuitry may be implemented as a chip or a processor, for example. It should be understood that various functional units in the electronic apparatus shown in FIG. 1 are only logical modules determined based on specific functions thereof, and are not intended to limit a specific implementation.

The electronic apparatus 100 may serve as a network-side apparatus in a wireless communication system, and may be specifically provided on a base station side or be communicatively connected to a base station, for example. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the electronic apparatus needs to execute to achieve various functions. The transceiver may include one or more communication interfaces to support communications with different devices (such as a server, a base station, and the like). An implementation of the transceiver is not specifically limited here.

The base station may be an eNB or gNB, as an example.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art may understand that the wireless communication system according to the present disclosure may be a 4G or 3G communication system.

The primary system (which includes a base station and user equipment) has a priority right in spectrum resource access, and the secondary system (which includes a base station and user equipment) does not have a legal right in spectrum access. In technical requirements for spectrum sharing, as long as an aggregate interference intensity generated by all secondary systems to a primary system receiver is lower than an interference protection threshold of the primary system, the secondary systems are still allowed to utilize the spectrum resources.

For example, in centralized federated learning, the electronic apparatus 100, i.e., the spectrum management device, may serves as a federated learning server and obtain the primary system behavior model through federated learning, or may obtain the primary system behavior model from a federated learning server (e.g., NWDAF) without participating in federated learning. In addition, for example, in distributed federated learning, the spectrum management device may serve as a federated learning client and obtain a local primary system behavior model through federated learning.

In an embodiment according to the present disclosure, a network is divided into multiple federated prediction regions based on the secondary systems. Instead of performing federated learning on the entire network, the primary system behavior model is obtained through federated learning for each federated prediction region of at least one of the multiple federated prediction regions. That is, through federated learning in each of the federated prediction regions, a corresponding primary system behavior model is obtained, which is applicable to a spectrum sharing scenario in the field of wireless communications. The primary system behavior model may be, for example, a deep learning model, which may be used for power prediction of a primary system.

In large-scale network scenarios, global federated learning may lead to problems of high communication latency and high model complexity.

By dividing the federated prediction region, at least one of the following technical benefits can be achieved. A communication cost can be reduced, and a scope of local model data analysis in federated learning can be constrained by reducing a size of the federated prediction region, so that a model complexity is reduced. All base stations within the federated prediction region participate in the federated learning, and therefore local training data of base stations can be more fully utilized, that is, a model accuracy is improved while reducing overhead. In addition, the network is divided into multiple federated prediction regions, and a spectrum prediction task of the network is divided into multiple federated prediction regions. In a case where a single-point failure occurs in a center for model aggregation in a single federated prediction region, other federated prediction regions are still able to complete the federated learning. Compared with other spectrum sensing technologies, a future received power of a primary system signal in a specific region can be predicted, instead of simply determining a shutdown status of the primary system. Availability of spectrum resources in spatial and temporal dimensions can be discovered more accurately, and thereby a received power of the primary system in different regions is predicted more effectively for spectrum resource sensing.

As an example, the spectrum management device, i.e., the electronic apparatus 100 may determine a final global model obtained from a federated learning server as the primary system behavior model. The federated learning server aggregates local primary system behavior models (hereinafter sometimes referred to as local models) trained by respective federated learning clients participating in the federated learning, to obtain the final global model.

Hereinafter, the federated learning client is sometimes referred to as FL-Client, and the federated learning server is sometimes referred to as FL-Sever. Federated learning that includes a federated learning server and a federated learning client is called centralized federated learning.

As an example, the federated learning server may be implemented by NWDAF (Network Data Analytics Function) of a 5G core network.

As an example, the federated learning server transmits a federated learning request to other devices within a federated prediction region associated with the federated learning server, and receives a federated learning response from other devices that agree to participate in the federated learning.

As an example, the federated learning response includes the quantity of geographical units occupied by user equipment in secondary systems associated with the federated learning clients.

As an example, the federated learning server is configured to: in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and stop the federated learning after a predetermined condition is met, and obtain the final global model. As an example, the predetermined condition includes that the final global model reaches a predetermined accuracy (for example, the final global model converges) and/or a predetermined number of rounds of training is performed.

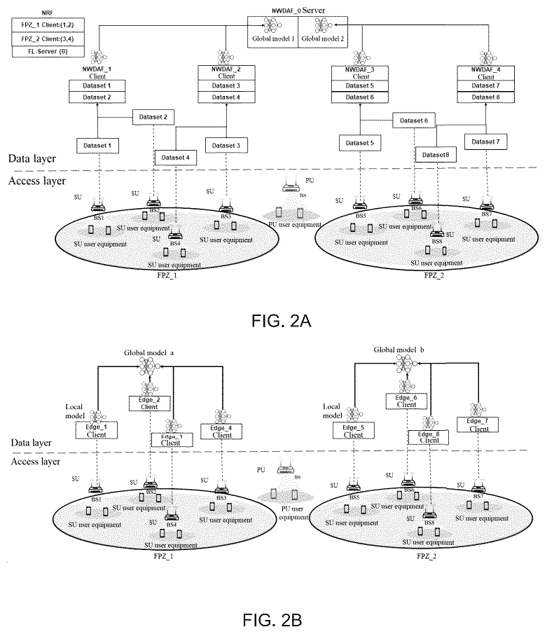

FIG. 2(a) illustrates an example of a system structure according to an embodiment of the present disclosure.

FIG. 2(a) relies on the federated learning framework in the 3GPP TS 23.288 standard. The base stations in the secondary systems upload collected data to the corresponding NWDAF.

In FIG. 2(a), a primary system is represented as PU and a secondary system is represented as SU. The SU is able to sense a signal of the PU and upload collected information to an apparatus or function connected thereto. The system includes an access layer and a data layer. A bottom layer is the access layer, which represents an access relationship between user equipment and a base station. The upper layer in the system structure in FIG. 2(a) is an abstract data layer. The data layer in FIG. 2(a) includes a core network NWDAF and an NRF (network repository function). In FIG. 2(a), there is one PU and multiple SUs. A base station in the PU is represented by BS. A base station set of multiple SUs is {BS1, BS2, BS3, BS4, BS5, BS6, BS7, BS8}. For illustration and not limitation, the base station set is divided into two federated prediction zones FPZ, i.e., federated prediction zone 1, namely FPZ_1, and federated prediction zone 2, namely FPZ_2, where FPZ_1={BS1, BS2, BS3, BS4} and FPZ_2={BS5, BS6, BS7, BS8}.

As shown in FIG. 2(a), for example, FPZ_1 includes NWDAF_1 and NWDAF_2. Base station BS1 uploads collected data Dataset 1 to NWDAF_1 corresponding thereto, base station BS2 uploads collected data Dataset 2 to NWDAF_1 corresponding thereto, base station BS3 uploads collected data Dataset 3 to NWDAF_2 corresponding thereto, and base station BS4 uploads collected data Dataset 4 to NWDAF_2 corresponding thereto. NWDAF_1 and NWDAF_2 serve as federated learning clients (for example, marked as FPZ_1 Client: {1,2} in the figure) and train their local primary system behavior models by using the collected data. NWDAF_0 serves as a federated learning server (for example, marked as FL-Sever: {0} in the figure) and globally aggregates local models to obtain a final global model (for example, global model 1). For FPZ_2, base station BS5 uploads collected data Dataset 5 to NWDAF_3 corresponding thereto, base station BS6 uploads collected data Dataset 6 to NWDAF_3 corresponding thereto, base station BS7 uploads collected data Dataset 7 to NWDAF_4 corresponding thereto, and base station BS8 uploads collected data Dataset 8 to NWDAF_4 corresponding thereto. NWDAF_3 and NWDAF_4, as federated learning clients (for example, marked as FPZ_2 Client: {3,4} in the figure), train local models by using the collected data. NWDAF_0, as a federated learning server, globally aggregates the local models to obtain a final global model (for example, global model 2).

The electronic apparatus 100 may obtain, from NWDAF_0, the global model 1 for FPZ_1 as a primary system behavior model for FPZ_1; and may obtain, from NWDAF_0, the global model 2 for FPZ_2 as a primary system behavior model for FPZ_2.

That is, the electronic apparatus 100 performs primary system power prediction through federated learning for at least one region of FPZ_1 and FPZ_2, and thereby provides reliable primary system behavior data for spectrum sharing.

As an example, the spectrum management device, that is the electronic apparatus 100 may serve as a federated learning server, and the primary system behavior model obtaining unit 103 may be configured to: determine, as the primary system behavior model, a final global model obtained by aggregating local primary system behavior models trained by one or more other spectrum management devices serving as respective federated learning clients participating in the federated learning. In this example, the spectrum management device, namely the electronic apparatus 100, may participate in federated learning as a federated learning server to obtain the primary system behavior model. For example, the electronic apparatus 100 may replace NWDAF_0 shown in FIG. 2(a) and serves as a federated learning server, and one or more other spectrum management devices may replace NWDAF_1 to NWDAF_4 shown in FIG. 2(a) and serve as federated learning clients, which is not described in further detail here.

As an example, the primary system behavior model obtaining unit 103 may be configured to transmit a federated learning request to other spectrum management devices within a federated prediction region associated with the electronic apparatus, and receives a federated learning response from other spectrum management device that agree to participate in the federated learning. As an example, a federated learning response includes the quantity of geographical units occupied by user equipment in secondary systems associated with the federated learning clients.

As an example, the primary system behavior model obtaining unit 103 may be configured to: in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and stop the federated learning after a predetermined condition is met, and obtain the final global model as the primary system behavior model. As an example, the predetermined condition includes that the final global model reaches a predetermined accuracy and/or a predetermined number of rounds of training is performed.

As an example, the spectrum management device, namely the electronic apparatus 100 may serve as a federated learning client, and the primary system behavior model obtaining unit 103 may be configured to: perform the federated learning in conjunction with one or more other spectrum management devices serving as federated learning clients; and determine, as the primary system behavior model, a global model obtained by aggregating local primary system behavior models trained by respective federated learning clients. For example, the spectrum management device, namely the electronic apparatus 100, serves as a federated learning client in distributed federated learning,

As an example, the spectrum management device, i.e., the electronic apparatus 100, is implemented by a base station in a secondary system or an edge server (edge computing node) associated with a secondary system.

FIG. 2(b) illustrates another example of a system structure according to an embodiment of the present disclosure. It should be noted that the system structure according to the embodiment of the present disclosure is not limited to FIG. 2(a) and FIG. 2(b), and there are various other variations.

FIG. 2(b) shows a solution of distributed federated learning based on edge computing, in which local training and model aggregation in federated learning are performed by a base station or edge server.

The system in FIG. 2(b) includes an access layer and a data layer. A bottom layer is the access layer, which represents an access relationship between user equipment and a base station. An upper layer in the system structure is an abstract data layer, and the data layer is composed of edge servers of base stations, for example. In FIG. 2(b), there is one PU and multiple SUs. A base station in the PU is represented by BS. A base station set of multiple SUs is N={BS1, BS2, BS3, BS4, BS5, BS6, BS7, BS8}. For illustration and not limitation, the base station set is divided into two federated prediction zones FPZ, i.e., federated prediction zone 1, namely FPZ_1, and federated prediction zone 2, namely FPZ_2, where FPZ_1={BS1, BS2, BS3, BS4} and FPZ_2={BS5, BS6, BS7, BS8}.

As shown in FIG. 2(b), for example, there are eight edge computing nodes Edge_1 to Edge_8, which are associated with BS1 to BS8, respectively. For example, FPZ_1 includes Edge_1, Edge_2, Edge_3, and Edge_4. Each edge computing node serves as a federated learning client and trains a local model using data obtained from an associated base station. One edge computing node (for example, Edge_2) among Edge_1, Edge_2, Edge_3, and Edge_4 serves as a federated learning server and performs global aggregation on the local models to obtain a final global model (for example, global model a). For example, FPZ_2 includes Edge_5, Edge_6, Edge_7, and Edge_8. Each edge computing node serves as a federated learning client and trains a local model using data obtained from an associated base station. One edge computing node (for example, Edge_6) among Edge_5, Edge_6, Edge_7, and Edge_8 serves as a federated learning server and performs global aggregation on the local models to obtain a final global model (for example, global model b).

The electronic apparatus 100 be Edge_2, that is, the electronic apparatus 100 obtains the global model a for FPZ_1 as a primary system behavior model for FPZ_1; or the electronic apparatus 100 mat be Edge_6, that is, the electronic apparatus 100 obtains the global model b for FPZ_2 as a primary system behavior model for FPZ_2. For convenience of description, the edge server is also referred to as a spectrum management device. However, the electronic apparatus 100, such as Edge_2 or Edge_6, may not have functions of spectrum allocation and/or interference analysis.

As an example, the spectrum management device, i.e., the electronic apparatus 100, serves as a federated learning client in distributed federated learning, and the primary system behavior model obtaining unit 103 may be configured to transmit, to other federated learning clients, the quantity of geographical units occupied by user equipment in the secondary systems associated with the spectrum management device. For example, Edge_2 shown in FIG. 2(b) transmits, to Edge_1, Edge_3, and Edge_4, the quantity of geographical units occupied by user equipment in the secondary system associated with Edge_2.

As an example, the primary system behavior model obtaining unit 103 may be configured to: aggregate, based on weights, the local primary system behavior model trained by the spectrum management device and local primary system behavior models received from other federated learning clients through broadcasting, in each round of training of the federated learning, to obtain a global model (for example, Edge_2 shown in FIG. 2(b) aggregates, based on weights, the local primary system behavior model of Edge_2 and local primary system behavior models received from Edge_1, Edge_3, and Edge_4 through broadcasting, to obtain a global model), and use the global model as a new local primary system behavior model for a next round of training; and stop the federated learning after a predetermined condition is met, and obtain the final global model as the primary system behavior model. As an example, the predetermined condition includes that the final global model reaches a predetermined accuracy and/or a predetermined number of rounds of training is performed.

As an example, the multiple federated prediction regions are constructed based on geographical location of base stations in the secondary systems, and a size of the federated prediction region is reflected by a quantity of geographic units having a predetermined geographical dimension.

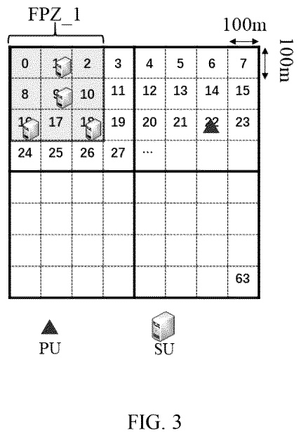

FIG. 3 illustrates an example of dividing a network according to an embodiment of the present disclosure.

As shown in FIG. 3, the network is divided into geographical units (also referred to as minimum units or minimum cells). By way of example and not limitation, a geographic unit may be a square cell of 100m×100m. The cells are numbered, as shown in FIG. 3, and the network is divided into a minimum unit set U={0, 1, 2, . . . , 63}.

For example, as shown in FIG. 3, the PU is located in the cell numbered 22, and the federated prediction region FPZ1 is a region of 3×3 unit cells, that is, including cells numbered 0, 1, 2, 8, 9, 10, 16, 17, and 18.

As an example, a quantity and locations of the federated prediction regions are determined through a k-means algorithm and a density-based spatial clustering algorithm DBSCAN for noisy applications, such combination of the k-means algorithm and DBSCAN may be referred to as a K-DBSCAN algorithm.

As an example, the k-means algorithm is applied to cluster base stations in the secondary systems, delete a cluster containing no base station without changing location of a cluster center, and set location of a specific base station in a cluster as a new cluster center in a case where a distance between the specific base station and a center of the cluster to which the specific base station belongs exceeds a first predetermined distance threshold; the DBSCAN algorithm is applied to input locations of cluster centers determined through the k-means algorithm to obtain new cluster centers, and merge cluster centers whose distances are less than a second predetermined distance threshold among the new cluster centers; and the k-means algorithm and the DBSCAN algorithm are repeated until the number of cluster centers no longer changes, wherein the cluster centers serve as centers of federated prediction regions and the number of the cluster centers corresponds to the number of the multiple federated prediction regions.

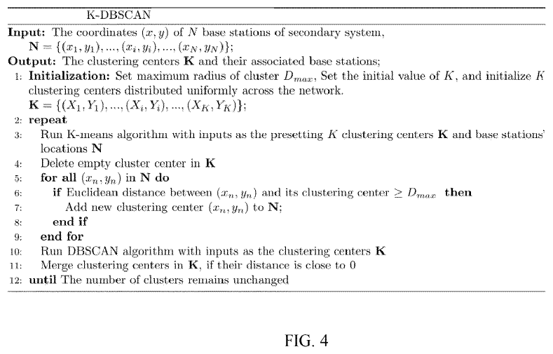

FIG. 4 illustrates an example of a pseudo code of a K-DBSCAN algorithm according to an embodiment of the present disclosure.

As an example, in the K-DBSCAN algorithm, an initial clustering K value of the network is set first. The initial K value should be set to the square of an integer to facilitate determining locations of K cluster centers. Since this value is not the final quantity of federated prediction regions, a larger value may be set initially. The initial K clustering centers are evenly distributed in the network. First, the k-means algorithm is run to perform initial clustering of base stations. When locations of the clustering centers do not change, a cluster that includes no base station is deleted. Then, when a distance between a base station in a cluster and a cluster center of the cluster exceeds a predetermined value Dₘₐₓ, the location of the base station is set as a new cluster center. The location of cluster center inputted to the DBSCAN algorithm to obtain a new cluster, and all the new cluster centers are finally traversed and cluster centers with similar distances are merged into new cluster centers. The distance is, for example, the Euclidean distance.

The pseudo code in FIG. 4 is described in conjunction with NWDAF. More specifically, the pseudo code of FIG. 4 is explained below.
Input: Coordinates (x,y): N={(x₁,y₁), . . . , (xᵢ,yᵢ), . . . , (x_{N}, y_{N})} of N base stations of the secondary system;
Output: cluster centers K and their associated base stations;
1: Initialization: Set a maximum radius Dₘₐₓ of a cluster. Set an initial value of K and initialize K cluster centers to be evenly distributed in the network.

$$K = \{ ( {X}_{1} , {Y}_{1} ) , … , ( {X}_{i} , {Y}_{i} ) , … , ( {X}_{K} , {Y}_{K} ) \} ;$$

2: Repeat steps 3 to 11 below
3: Run the k-means algorithm with an input as preset K cluster centers K and locations N of base stations
4: Delete empty cluster centers from K
5: Perform the following process for all (xₙ,yₙ) in N
6: if the Euclidean distance between (xₙ,yₙ) and its cluster center is greater than or equal to Dₘₐₓ, then
7: Add a new cluster center (xₙ,yₙ) to N;
8: End if
9: End for
10: Run the DBSCAN algorithm with an input as the cluster centers K
11: Merge cluster centers in K if their distance is close to 0
12: Repeat until the number of clusters remains unchanged

Traditional clustering algorithms such as k-means are limited by setting of the initial K value. Once the K value is determined, the number of clusters is a constant value, and there it is impossible to adaptively adjust the quantity of federated prediction regions. In addition, the k-means clustering algorithm can only process spherical clusters, that is, a solid group (this is because the algorithm itself is limited in calculating an average distance). There are often various shapes in reality, such as rings and irregular shapes. In these cases, a clustering algorithm based on high-density samples is applicable. The DBSCAN density-based clustering algorithm does not have a cluster center point, which results in irregular cluster shapes. After clustering, base stations located at cluster edges may be far apart. When a density of base stations is high, no valid clusters can be output or the quantity of clusters is too low. The K-DBSCAN algorithm retains the regular shape characteristics of the k-means algorithm after clustering, avoids the defect of being limited by setting of an initial K value, and is able to adaptively adjust the quantity of clusters. The purpose is that a federated prediction region formed after clustering is composed of base stations around a cluster center, so that primary system received signal strength information provided by a base station can be fully fed into a learning model. Therefore, the K-DBSCAN algorithm can optimize the quantity of clusters and thereby reduce the quantity of federated prediction regions.

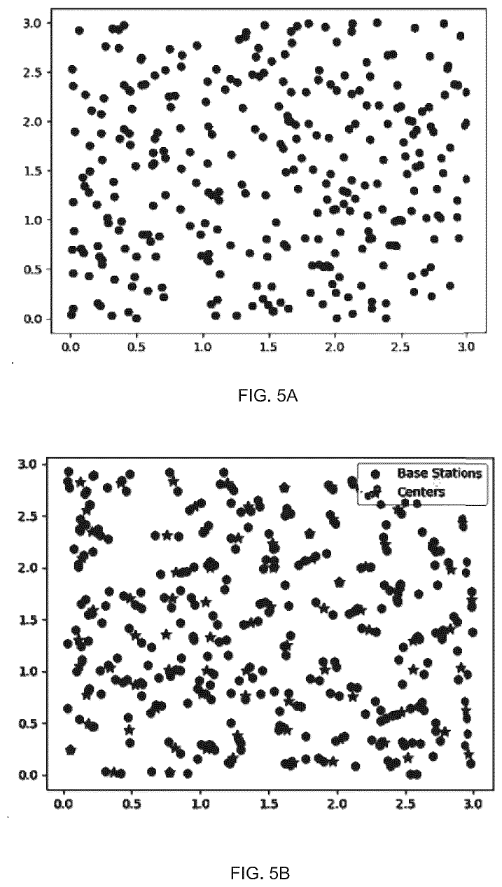

FIG. 5(a) and FIG. 5(b) illustrate examples of an effect of determining federated prediction regions through a K-DBSCAN algorithm according to an embodiment of the present disclosure. As shown in FIG. 5(a), a network size is set to 3 km×3 km, the quantity of base stations is 300, and dots in FIG. 5(a) represent distribution of the base stations. FIG. 5(b) shows an effect of clustering through the K-DBSCAN algorithm, where the stars represent locations of centers of 82 federated prediction regions (marked as Centers in the figure), and the dots represent distribution of base stations (marked as Base Stations in the figure). As can be seen from FIG. 5(b), the two-layer clustering algorithm (K-DBSCAN algorithm) can minimize the quantity of federated prediction regions, so that local data can be fully utilized in federated learning.

The method of obtaining the federated prediction regions in the embodiments of the present disclosure is different from the user clustering in the existing federated learning. The user clustering in the existing federated learning is to cluster and group users with similar data, select representative user data from a group for training, and thereby realize sampling of the data. A key point is that the clustering of users in existing federated learning technology does not affect a structure of a learning model in federated learning, but only screens training data. In an embodiment of the present disclosure, for example, clustering is performed based on geographical location distribution of base stations, and a size and location of the clustered federated prediction region determines an input and output target of the model in the federated learning. The federated prediction region decouples the primary system signal prediction problem in a large-scale network into prediction of multiple sub-regions. On the one hand, the communication overhead for centralized prediction data collection is reduced; and on the other hand, the computational complexity of model training is reduced.

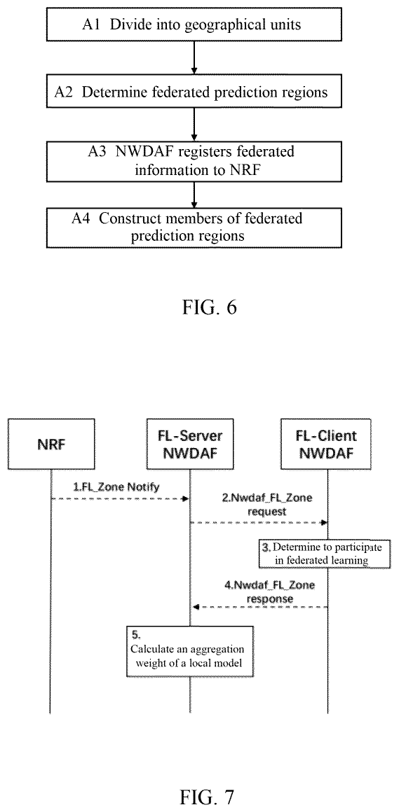

FIG. 6 illustrates an example of a process for constructing a federated prediction region according to an embodiment of the present disclosure. In FIG. 6, taking the system structure as in FIG. 2(a) as an example, a process of constructing federated prediction regions is as follows. The federated learning in FIG. 2(a) is centralized federated learning.

In A1, the network is divided into geographical units as shown in FIG. 3. In A2, the electronic apparatus 100 collects geographic location information of base stations, and determines the quantity and location of the federated prediction regions based on location information uploaded by the base stations, for example, by running the K-DBSCAN dual clustering algorithm. (It should be further noted here that in a case where the electronic apparatus 100 directly participates in federated learning as a federated learning server, the electronic apparatus 100 also collects the geographic location information of the base stations, and determines the quantity and location of the federated prediction regions based on the location information uploaded by the base stations, for example, by running the K-DBSCAN dual clustering algorithm). In A3, after division of the federated prediction regions is determined, a NWDAF needs to register federated learning information in the network. As shown in the example in FIG. 2(a), the network is divided into two federated prediction regions, FPZ_1 and FPZ_2. When a base station associated with a NWDAF is divided into a federated prediction region, the NWDAF registers with NRF as a federated learning client of the federated prediction region. A NWDAF which undertakes the task of aggregating federated learning models, is registered as a federated learning server. As shown in FIG. 2(a), federated prediction region 1, i.e., FPZ_1, includes {NWDAF_1, NWDAF_2}, federated prediction region 2, i.e., FPZ_2, includes {NWDAF_3, NWDAF_4}, and NWDAF_0 is registered as FL-Server. In A4, after the federated learning information is registered, the NWDAF corresponding to the federated prediction regions constructs members of federated prediction regions (forms federated learning groups).

FIG. 7 is a schematic diagram showing information interaction for constructing a federated learning group according to an embodiment of the present disclosure. This is described in conjunction with FIG. 2(a). First, the NRF notifies, through FL_Zone Notify, a NWDAF (for example, NWDAF_0 in FIG. 2(a)) which serves as a federated learning aggregation point to become FL-Server of the federated prediction region. This information further includes identity information of other FL-Clients (for example, NWDAF_1 to NWDAF_4 in FIG. 2 (a)) in a current federated prediction region. The FL-Server requests, through NWDAF_FL_Zone Request, FL-Client to participate in the federated prediction region. If the FL-Client confirms to participate in the federated learning, the FL-Client transmits NWDAF_FL_Zone Response to FL-Server for confirmation. The NWDAF_FL_Zone Response information may further include the quantity of geographical units occupied by user equipment in a secondary system corresponding to an FL-Client, in order to provide guidance for subsequent model aggregation of the federated learning, for example, for calculating an aggregation weight of a local model based on this quantity.

Taking the system structure as in FIG. 2(b) as an example, a process of constructing federated prediction regions is as follows. In B1, the network is divided into geographical units. In B2, for example, the K-DBSCAN algorithm is run to cluster base stations and divide the network into federated prediction regions. Here, in the distributed federated learning network shown in FIG. 2(b), the division into federated prediction regions may be performed by a network management OAM (Orchestration and management) or another centralized spectrum management device. In B3, After the division into federated prediction regions, base stations or edge servers in a same federated prediction region form a federated learning group. As shown in FIG. 2(b), federated prediction region 1, i.e., FPZ_1, includes {Edge_1, Edge_2, Edge_3, Edge_4}, federated prediction region 2, i.e., FPZ_2, includes {Edge_5, Edge_6, Edge_7, Edge_8}.

In order to optimize a computing energy consumption and communication energy consumption in the federated learning model, an overall energy consumption of the model is reduced as much as possible while meeting an accuracy requirement of the model in different specific scenarios. The computing energy consumption comes from local model training, and the communication energy consumption comes from model parameter aggregation. Since the two parts of energy consumption are relatively independent from each other in the entire model training environment, they can be optimized separately, so that the difficulty of solving the optimization problem is reduced. In the optimization of computing energy consumption of federated learning, an optimal range (for example, a rectangle with a unit of the minimum cell) may be determined for each federated prediction region, so that the energy efficiency (accuracy/energy consumption) of the federated learning is optimized as the federated learning converges. In the optimization of communication energy consumption of distributed federated learning, location of a federated aggregation point for local model aggregation (also referred to as model aggregation) may be selected based on a real-time channel state (that is, a federated learning client (hereinafter also referred to as an access point (AP)) is selected for local model aggregation) to minimize the overall communication energy consumption. Thereby, the overall energy efficiency of federated learning is improved.

An example of determining an optimal range for each federated prediction region is described below.

As an example, a lower limit of sizes of the multiple federated prediction regions is determined based on a distance between a center of a federated prediction region and a secondary system, and each federated prediction region is updated and determined based on accuracy and/or energy consumption when a primary system behavior model converges.

The accuracy and/or energy consumption may be collectively referred to as energy efficiency.

Steps for determining this federated prediction regions are as follows:
1.1 Determining a lower limit of a size of a federated prediction region through a geometric method;
1.1.1 Obtaining a center for each federated prediction region and location of base stations included in the federated prediction region based on the K-DBSCAN algorithm or the k-means clustering algorithm;
1.1.2 Calculating, based on the horizontal and vertical coordinates, a maximum distance from the center point to a base station among the base stations, recorded as Δx and Δy;
1.1.3 Taking the maximum value of Δx and Δy, rounding and multiplying it by 2 as a minimum radius of the federated prediction region;
1.2 For each federated prediction region, based on a lower limit of the federated prediction region and the idea of finding an extreme value of a function through the three-point method in calculus, training three federated learning models (local models) in parallel, evaluating energy efficiencies of the three models after convergence, and then updating parameters with the “three-point method” to determine learning models of three different dimensions. Main steps of the three-point method are as follows:
1.2.1 Taking a minimum radius r0 as a benchmark, take r1=r0+s and r2=r0+2*s, and using r0, r1 and r2 as radii to correspond to the federated learning model of three input dimensions, respectively (where s represents a step factor).
1.2.2 Training the three models separately in same environment, and calculating energy efficiencies of the three models at convergence, corresponding to E0, E1 and E2 respectively.
1.2.3 Updating r0, r1, and r2 according to different situations, including:
(1) E0<E1<E2, r0=r1, r1=r2, r2=r2+s
(2) E0>E1>E2, and r0−s>minimum radius, r0=r0−s, r1=r0, r2=r1
(3) E0>E1>E2, and r0−s<minimum radius, and s<1, optimal radius=r0,
(4) E0<E2<E1, and s>2, s=s/2, r0=r1, r1=r0+s
(5) E2<E1<E1, and s>2, s=s/2, r0=r1, r1=r2−s, r2=r1
(6) For the relationship between E0, E1, and E2 in (4) and (5), if there has s<2, a radius corresponding to the maximum energy efficiency is outputted.
1.2.4 Repeating 1.2.2 to 1.2.3 until a predetermined condition is met.
1.3 Outputting the optimal radius of each federated prediction region.

It should be noted that the optimal region may not be a circular region.

An example of selecting a federated aggregation point (also referred to as a model aggregation point or aggregation point) for local model aggregation in distributed federated learning is described below.

As an example, in a case where the spectrum management device, namely the electronic apparatus 100 serves as a federated learning client in the federated learning, the spectrum management device, namely the electronic apparatus 100 is selected to perform the aggregation when the following predetermined condition is satisfied: based on channel information between the spectrum management device and the one or more other spectrum management devices, calculating a sum of transmission energy consumptions of transmission paths between the spectrum management device and the one or more other spectrum management devices in a case where the spectrum management device serves as an aggregation device for aggregating local primary user behavior models within federated prediction regions associated with the spectrum management device, where a sum of transmission energy consumptions in a case where the spectrum management device serves as an aggregation device is less than a sum of transmission energy consumptions in a case where any one of the one or more other spectrum management devices serves as the aggregation device.

As an example, the primary system behavior model obtaining unit 103 may be configured to exchange channel information with one or more other spectrum management devices through broadcasting.

As an example, the transmission energy consumption of a transmission path is calculated based on a transmission rate and transmission power of the transmission path.

Here, the spectrum management device and the one or more other spectrum management devices are collectively referred to as APs for illustration. The channel state information is shared among all APs in each federated prediction region (cluster). The APs are selected in turn, and each AP calculates and records a result of the communication energy consumption of the other APs when the AP performs model aggregation. After each of the APs has calculated an aggregation energy consumption when the AP itself serves as an aggregation point (i.e., an aggregation device, or an aggregation center), all the APs share energy consumption information with each other, and then select an AP with the minimum energy consumption as the model aggregation point. That is, when determining an aggregation center, the APs exchange channel information with each other through broadcasting, for each of the different APs, an overall communication energy consumption when different AP serves as an aggregation center is calculated based on the channel information, and the AP corresponding to the minimum communication energy consumption is determined as an aggregation center for the federated learning.

FIG. 8 illustrates an example of selecting a federated aggregation point for local model aggregation according to an embodiment of the present disclosure.

As shown in FIG. 8, in a case where AP1 is selected as the aggregation point, there are three wireless transmission paths between AP1 and other APs, namely AP2 to AP4. The transmission rates corresponding to the three wireless transmission paths may be calculated based on the free space loss model and the Rayleigh fading model, and the transmission energy consumptions may be further calculated based on the transmission powers. A sum of the transmission energy consumptions corresponding to the three wireless transmission paths is less than a sum of transmission energy consumptions when any one of the AP2 to AP4 serves as an aggregation device.

Considering a time slot system, that is, at the beginning of each time slot, a terminal (user equipment) of a secondary system reports a received PU signal power to a base station to which the terminal belongs. A goal of using the primary system behavior model is to predict a future signal reception strength based on PU historical received signal strength.

As an example, the primary system behavior model is a multi-input multi-output long short-term memory neural network model (LSTM model for short).

Using of a single-input single-output LSTM increases the quantity of models in the system, leading to an increase in communication overhead. In the present disclosure, during the federated aggregation process with the multiple-input multiple-output LSTM, the federated learning client (aggregation client) only needs to transmit a single local model and does not need to create communication connections multiple times with an apparatus or function for model aggregation, and thereby communication overhead is reduced.

As an example, a dimension of input and output of the multi-input multi-output long-short term memory neural network model is determined by a size of a federated prediction region.

As an example, for each federated prediction region, an input of the multi-input-multi-output long-short term memory neural network model is information of primary system signal received power of all geographical units in the federated prediction region in a predetermined quantity of historical time slots, and an output of the multi-input-multi-output long-short term memory neural network model is a predicted value of a primary system signal received power of each geographical unit in a next time slot.

Although the primary system signal received power is different depending on geographical units at different locations, a change trend of the signal of the primary system is consistent. Therefore, using information of the primary system signal received power of all the multiple geographical units as an input of the LSTM model can better learn a power change of the primary system.

As an example, the primary system behavior model is obtained by aggregating local primary system behavior models obtained from federated learning clients participating in the federated learning.

For example, a federated learning client obtains a local primary system behavior model by training local data. The primary system behavior model may be obtained through aggregation on the local primary system behavior models.

As an example, local primary system behavior models corresponding to the federated learning clients are aggregated by calculating weights based on the quantity of geographical units occupied by user equipment in secondary systems associated with the federated learning clients.

It is assumed that the federated prediction region includes N FL-Clients, and a SU-related quantity set of the N FL-Clients in the federated prediction region thereof is S={S₁, S₂, . . . , Sₙ, . . . , S_{N}}, where Sₙ represents the quantity of geographical units occupied by user equipment in the secondary system associated with the nth FL-Client. It is assumed that a local model parameter set of an FL-Client is

$$W = \{ {W}_{1}^{L} , {W}_{2}^{L} , … , {W}_{n}^{L} , … , {W}_{N}^{L} \} ,$$

where

$${W}_{N}^{L}$$

represents a local model parameter of the nth FL-Client. It is assumed that the quantity of geographic units in the federated prediction region is M.

A set of weights A={α₁, α₂, . . . , αN} of the model may be calculated through equation (1):

$${α}_{n} = \frac{{e}^{{S}_{n} / M}}{{\sum }_{i = 1}^{N} {e}^{{S}_{i} / M}} \qquad ( 1 )$$

In the equation, S/M represents normalization of the quantity of geographical units occupied by user equipment in secondary systems associated with the FL-Client. Application of an exponential function after the normalization can protect a local primary system behavior model with sparse SU distribution and avoid an excessive low weight of the local primary system behavior model in aggregation. After the weights are calculated, local models may be aggregated based on the weights. For example, the local model parameters are multiplied by the weights and then summed up to obtain a parameter

$${W}^{G} = {\sum }_{n = 1}^{N} {α}_{n} {W}_{n}^{L}$$

of a global model.

As an example, when a federated learning client transmits a local model to an apparatus configured for model aggregation (for example, a federated learning server, or a federated learning client for model aggregation in distributed federated learning), the quantity of geographical units occupied by user equipment in the associated secondary system is transmitted, and location of the user equipment in the associated secondary system is not transmitted. Location information is private information. Disclosing of the location may lead to a risk of being attacked or monitored. In the embodiment according to the present disclosure, location of user equipment in the SU is avoided from being provided, so that user privacy is protected. That is, during the model aggregation process, the FL Client dies not reveal location information of the user equipment in the current SU, but only transmits the quantity of geographical units occupied by the user equipment in the associated secondary system. Hence, security of location privacy information of the SU is ensured.

As an example, local primary system behavior models corresponding to the federated learning clients are aggregated by calculating weights based on a distribution status of user equipment in secondary systems associated with the federated learning clients. The weight aggregation method based on the embodiment of the present disclosure can effectively screen the local models, thereby improving the accuracy of the federated learning model.

For example, an aggregation weight of the FL client may be calculated based on distribution of user equipment in the secondary systems. In a case where geographical location of user equipment is relatively concentrated (users are concentrated in a few locations and there are no users in other locations, and therefore only the power information of primary users in a few locations can be perceived), only an accurate prediction of power of a primary user in a local area can be provided. In this case, the aggregation weight of the FL client is relatively low. In a case where distribution of user equipment is relatively uniform (users are evenly distributed in different locations, and therefore power information of primary users in more locations can be perceived, and the signal strength of primary users in more locations can be obtained, so that better-quality training data is available when training local models), the FL client has a higher aggregation weight.

That is, in the federated learning scheme, weighted model aggregation is performed, where a weight is calculated through a distribution status of users served by a base station in the secondary system. In a case where the users served by the base station are evenly distributed in a federated prediction region, the local model provided by the base station has a higher weight. The principle is that a base station with evenly distributed users can obtain the signal strength of primary users at more locations, and therefore the base station has better training data when training the local model. When performing global model aggregation, network parameters of the local models constitute network parameters of the global model in a weighted form.

As an example, local primary system behavior models are aggregated by calculating weights based on a model accuracy of the local primary system behavior models corresponding to the federated learning clients.

For all federated learning clients (APs) within a federated prediction region, user data owned by each AP may be different, and therefore it is necessary to assign different weights to the models trained by different APs when performing federated aggregation. The weight assigning scheme may be implemented by assigning based on a model accuracy, and a model weight is determined from a direct or indirect accuracy expression.

As an example, a model accuracy of a local primary system behavior model increases as a user data volume involved in the local primary system behavior model increases, and decreases as a loss of the local primary system behavior model increases. Based on the aggregation method in which weights are assigned according to the model accuracy according to the embodiment of the present disclosure, a model training speed is improved and the energy consumption overhead of the model to converge is reduced.

For example, the accuracy of a deep learning model that serves as the primary system behavior model may be defined as a proportion of the number of pieces of correct data to the total number of pieces of data, but this definition is not applicable in practice. Therefore, it is necessary to design an expression that indirectly represents the model accuracy. For example, a function of user data volume and model loss may be designed, whose value increases as the user data volume increases and decreases as the model loss decreases. Compared with the general average weight assigning method, this method for determining an aggregation weight enables a local model with higher model accuracy to have a higher weight during aggregation. After the aggregation, the federated learning model can converge faster, so that the number of rounds of aggregation communication at the communication level is reduced, and thereby the communication energy consumption is reduced.

For example, calculation of a weight of a local model is designed as follows: a fraction with a logarithm of user data volume as the numerator and a model loss as the denominator. Using a logarithmic function of the user data volume as the numerator ensures monotonic increasing thereof and reasonably reflects a trend of impact of the user data volume on model accuracy. Using the model loss as the denominator ensures monotonic decrease thereof and fully reflects an important impact of local model fitting effect on an overall effect of the federated learning model.

As an example, when determining an aggregation weight, the following equation (2) may be applied:

$${ω}_{n} = \frac{Indicator ( n )}{{\sum }_{n = 1}^{\vert {C}_{i} \vert} Indicator ( n )} \qquad ( 2 )$$

where there has Indicator(n)=log₂(1+dₙ)/ηₙ.

In the above two equations, ωₙ represents weight of a local model of the nth AP in a federated prediction region, |Cᵢ| represents the quantity of APs in a federated prediction region, dₙ represents a magnitude of user data volume owned by the nth AP, and ηₙ represents loss of a local model of the nth AP.

For a same model, a larger federated aggregation period (model aggregation period) leads to a higher convergence speed and a higher loss when convergence is reached; and a smaller federated aggregation period leads to a lower convergence speed and a lower loss when convergence is reached. Based on this, in optimization of an overall energy consumption of federated learning, a function of the federated aggregation period may be designed, through which a period of each round of aggregation is calculated and determined. As an example, the communication computing energy consumption under different aggregation periods may be calculated to determine an aggregation period that minimizes the energy consumption.

In an embodiment according to the present disclosure, a function of a federated aggregation period is designed, which decreases monotonically with time. By continuously adjusting the aggregation period based on the function of the federated aggregation period, a compromise is made between the accuracy of the federated learning model and the convergence speed. The number of rounds of communication of parameter aggregation is reduced while ensuring a certain model accuracy, and thereby the communication energy consumption of model training is reduced.

As an example, as a loss of the primary system behavior model decreases monotonically, a period of the aggregation decreases monotonically.

As an example, in a case where a loss of the local primary system behavior model does not monotonically decrease, a period of the aggregation is reduced according to a predetermined proportion.

When determining the aggregation period, each federated prediction region records the aggregation period of a previous time slot and a loss at the current time instant. In consideration of possible fluctuations in loss during model training, when the loss shows a monotonically decreasing trend, the designed monotonically decreasing function is applied to update the model aggregation period. In other cases, the model aggregation period is reduced by a fixed proportion.

$$F ( x ) = \frac{1}{N} {\sum }_{i = 1}^{N} f ( x ; {s}_{i} ) \qquad ( 3 )$$

$${x}_{k + 1}^{i} = \{ \begin{matrix}\frac{1}{m} {\sum }_{j = 1}^{m} ( {x}_{k}^{j} - {η}_{k} g ( {x}_{k}^{j} ) ) , & k mod τ = 0 \\ {x}_{k}^{i} - {η}_{k} g ( {x}_{k}^{i} ) , & k mod τ \neq 0\end{matrix} \qquad ( 4 )$$

$${τ}_{l} = \{ \begin{matrix}\sqrt{\frac{F ( {x}_{t = {lT}_{0}} )}{F ( {x}_{t = 0} )}} {τ}_{0} , & if \sqrt{\frac{F ( {x}_{t = {lT}_{0}} )}{F ( {x}_{t = 0} )}} {τ}_{0} < {τ}_{l - 1} \\ \frac{1}{2} {τ}_{l - 1} , & otherwise\end{matrix} \qquad ( 5 )$$

Here, F(x) in equation (3) represents an average loss of the federated model, f(x;sᵢ) represents a loss of each local model in federated learning, x represents a local model parameter, and s represents a training data set.

Equation (4) represents update iteration of the model parameter. An upper branch in equation (4) represents an update of the federated aggregation mode, k mod τ=0 represents that a time node for the federated aggregation is reached, and therefore all local models are aggregated and an aggregation result is transmitted to each local model to complete update of the parameter. Here, τ represents a federated aggregation period. A lower branch in equation (4) represents an independent update of a local model, k mod τ≠0 represents that a time node for the federated aggregation is not reached, and each local model updates a parameter only based on its own training result. Here, g( ) represents a stochastic gradient, ηₖ represents a preset parameter.

Equation (5) represents update iteration of the federated aggregation period, where T0 represents a preset time parameter, τ₀ represents an initial federated aggregation period, and 1 represents a positive integer greater than 1. The two parts in equation (5) represent rules for updating the federated aggregation period under different conditions, respectively. The upper branch represents a general situation, in which the federated learning model is assumed to be trained in an overall positive trend, that is, the model loss decreases, and thereby the federated aggregation period decreases. The lower branch represents a special situation, in which fluctuations that may occur during the training of the federated learning model is considered, that is, a certain update may cause the federated learning model to develop in a negative trend, but it is still necessary to reduce the federated aggregation period in order to ensure a final effect of the model. It should be noted that for special cases, ½ is only a reference value. In theory, any value set in a range of (0, 1) is acceptable.

The LSTM model network parameters are set so that the input of the model is T×M dimensional, where T represents the above-mentioned predetermined quantity of historical time slots, and M represents the quantity of all geographic units included in a corresponding federated prediction region.

In a case where the model training and aggregation functions of federated learning are in the core network (for example, NWDAF) (as shown in FIG. 2(a)), a computing power of the core network is sufficient and there is no need to consider computational overhead of federated learning when training the federated learning model. Therefore, no upper limit is set for the input T (predetermined quantity of historical time slots) of the LSTM model.

In contrast, in a case where the model training and aggregation functions of federated learning are implemented by an edge computing node (edge server) of a base station (as shown in FIG. 2(b)), the edge server generally has a limited computing power and has to further handle computing tasks in an access network. Therefore, it is necessary to consider their computing overhead in the federated learning.

When considering the computational overhead, the primary user received power prediction under the system structure shown in FIG. 2(b) mainly includes the following steps T1 to T5.

Step T1 is described first. The input and output dimension of the LSTM model is determined according to the size of the federated prediction region. In the example shown in FIG. 3, the federated prediction region 1 consists of a 3×3 minimum cell region. In this case, an input of the LSTM model contains PU signal received power information of 9 minimum cells. The computing power of the FL-Client is to be considered when determining the input and output dimension of the model. An average computing power of the FL-Client is assumed to be C, expressed in cycles/second, indicating the number of CPU periods executable per second. It is assumed that local training of the user in each time slot takes a time τ, and the number of iterations of local training is γ.

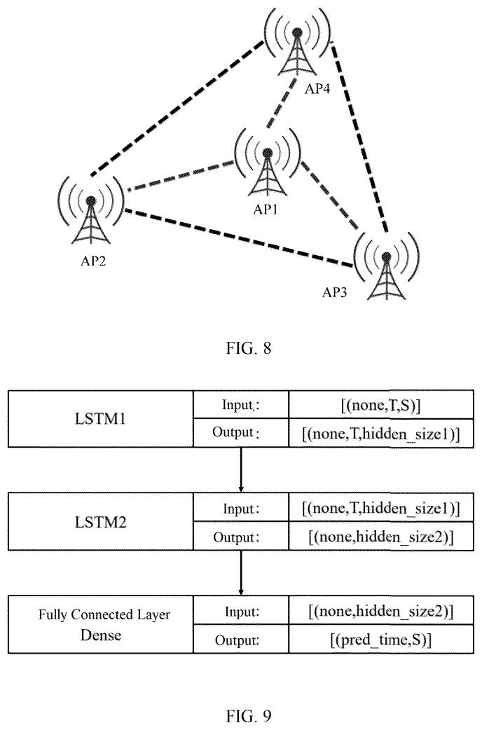

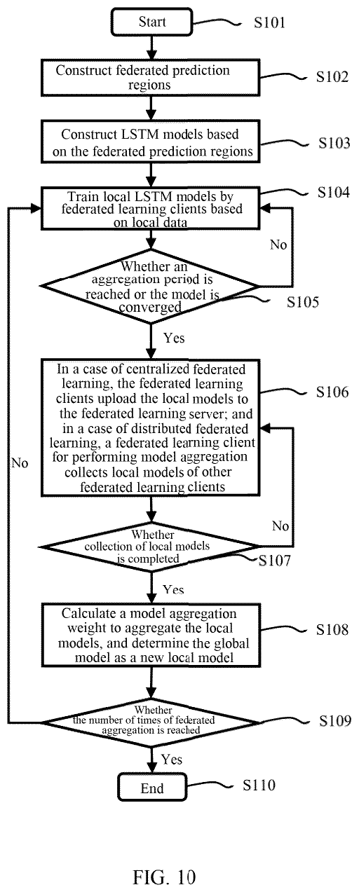

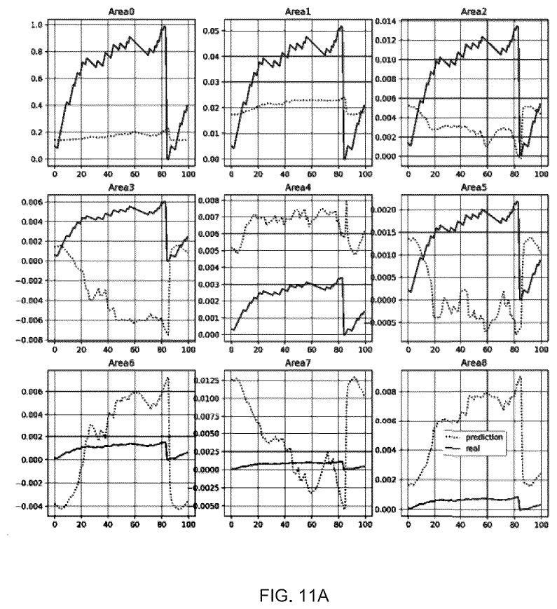

FIG. 9 illustrates is an example of a structure of an LSTM network model according to an embodiment of the present disclosure. In FIG. 9, T represents the number of inputted historical time slots, S represents a size of a federated prediction region (in the example shown in FIG. 3, there has S=9), and none represents an intermediate parameter during model operation. In addition, hidden_size1 and hidden_size2 represent the number of hidden nodes of the two-layer LSTM, and pred_time represents the number of predicted future time slots.

The computational complexity of the LSTM layer is analyzed. The LSTM mainly includes input gate, forget gate, output gate and cell state update. Taking time instant t as an example, the input gate inputₜ is calculated as inputₜ=σ(Wᵢᵢxₜ+bᵢᵢ+Wₕᵢhₜ₋₁+bₕᵢ). Here, σ represents the Sigmoid activation function, Wᵢᵢ represents an input gate network weight, with a dimension of (H, T×S), where H represents the number of hidden nodes. In addition, xᵢ represents an input with a dimension T×S; bit represents a bias value with a dimension H; Wₕᵢ represents a network weight that retains a hidden state of the input at the previous time instant, and a dimension thereof is (H, T×S); hₜ₋₁ represents a hidden state at the previous time instant, and a dimension thereof is H; and bₕᵢ represents a bias value with a dimension H. Through matrix multiplication and addition operations inside the activation function, a complexity is calculated as O(H×T×S+2H+H²). When the Relu activation function is applied, an input gate calculation complexity is O(4(H×T×S+2H+H²)). Through similar calculation of the computational complexity of the forget gate forgetₜ=σ(W_{if}xₜ+b_{if}+W_{hf}hₜ₋₁+b_{hf}) and the output gate outₜ=(σ(Wᵢₒxₜ+bᵢₒ+Wₕₒhₜ₋₁+bₕₒ), the cell state update gₜ=tan h(W_{ig}xₜ+b_{ig}+W_{hg}hₜ₋₁+b_{hg}), the final LSTM output hidden state hₜ=outₜ⊙cₜ₋₁, and the cell state cₜ=forgetₜ⊙cₜ₋₁+inputₜ⊙gₜ, a computational complexity of a single-layer LSTM is obtained as O(4(H×T×S+3H+H²)). Similarly, the second layer LSTM, LSTM2, uses the input of the first layer LSTM, LSTM1, as output for operation, obtaining a computational complexity of the two-layer LSTM as O(4(H₁×T×S+3H₁+H₁²)+4(H₂×H₁+3H₂+H₂²)), where H₁ and H₂ are hidden_size1 and hidden_size2, respectively, representing the number of hidden layer nodes. Finally, a fully connected layer (Dense) is added. Therefore, a forward propagation of the final network has a complexity O_{f}=O(4(H₁×T×S+3H₁+H₁²)+4(H₂×H₁+3H₂+H₂²)+H²(T_{pred}×S+1)). A backward propagation of the network has the same complexity as the forward propagation. Therefore, the final complexity is Oₜᵣₐᵢₙ=2O_{f}. According to the calculated complexity, the input historical time slot length of a current FL-Client when meeting a time limit requirement can be obtained, that is,

$$τ \geq \frac{α \times γ \times {O}_{train}}{C} ,$$

where α represents a calculation density, that is, the number of CPU periods required to perform one operation. By applying a maximum delay as the training time, the input historical time slot length

$$T = \frac{\frac{τ C}{2 αγ} - ( 12 ( {H}_{1} + {H}_{2} ) + 4 ( {H}_{1}^{2} + {H}_{2}^{2} ) + 4 {H}_{1} {H}_{2} + {H}_{2} {T}_{pred} S + {H}_{2} )}{4 {H}_{1} S}$$

may be calculated.

Step T2 is described next. A Tensorflow-based LSTM deep neural network is constructed based on the parameter calculated in step T1. For example, a deep neural network constructed with T=10 may be used, that is, 10 historical time slots may be used to predict a PU received power of a further one time slot. Combined with S=9 in the example shown in FIG. 3, an input dimension of the LSTM deep neural network is 10×9=90, and an output dimension is 9. The input and output dimension in this embodiment is merely an example. The input and output dimension should be adjusted as the federated prediction region changes. For example, in a case where the number of minimum cells in the federated prediction region is M and a predicted time slot length is pred_time, the input dimension is T×M and the output dimension is M×pred_time.

A network structure that is, parameter, of the LSTM is assumed as follows.

A first layer is a standard LSTM layer implemented by Keras (an open-source artificial neural network library), and has an input data dimension (9,10), 128 hidden nodes, and a Sigmoid activation function.

A second layer is a standard LSTM layer implemented by Keras, and has 64 hidden nodes and a Sigmoid activation function.

A third layer is the fully connected layer.

Step T3 is described next. After the LSTM deep neural network is built, the FL-Client trains the model based on local data. For example, a loss function of model training is defined as a mean square error between a PU predicted received power and an actual received power. When the local training converges or reaches the number of iterations, the FL-Client broadcasts the model parameter in the federated prediction region. For example, as shown in FIG. 2(b), Edge_1 in FPZ_1 passes the trained local model parameter to {Edge_2, Edge_3, Edge_4}. Similarly, other edge computing nodes pass the model parameters to Edge_1.

Step T4 is described next. On reception of local model parameters of all the federated prediction regions, the FL-Client performs weighted aggregation on the model parameters. The weight may be determined based on at least one of equation (1), equation (2), or a distribution status of user equipment in secondary systems associated with the federated learning client.

Step T5 is described finally. The FL-Client determines the aggregated global model as a local model and performs a new round of training based on local data. Steps T3 to T5 are repeated until a predetermined condition is met. The predetermined condition includes that the global model reaches a predetermined accuracy or a predetermined number of rounds of training is performed.

The primary user received power prediction under the system structure shown in FIG. 2(a) mainly includes the following steps S1 to S5.

Step S1 is described first. The LSTM model network parameters are set. The input of the model is T×M dimensional, where T represents the number of historical time slots. Since the core network server has sufficient computing power, no upper limit is set for the T value. In addition, M represents the number of minimum cells corresponding to a federated prediction region.

Step S2 is described then. Similar to step T2 described above in conjunction with FIG. 2(b), an LSTM deep neural network is constructed.

Step S3 is described next. The NWDAF serving as FL-Client collects data uploaded by the base station governed by the NWDAF. As shown in FIG. 2(a), there are four base stations in the federated prediction region 1 (i.e., FPZ_1), and a data set collected by the base stations is {Dataset 1, Dataset 2, Dataset 3, Dataset 4}. For example, the base station governed by NWDAF_1 includes {BS1, BS2}, and therefore the collected data is {Dataset 1, Dataset 2}. Since coverages of the base stations may overlap with each other, the FL-Client needs to pre-process the collected data set. A specific method for pre-processing includes: in a case where received powers of multiple primary system received signals corresponding to minimum cells at the same position exist in the data set, averaging the received powers of the primary system signals.

Step S4 is described next. After the FL-Client training model converges or the aggregation period is reached, the FL-Client uploads the model parameter to the NWDAF that serves as the FL-Server. As shown in FIG. 2(a), NWDAF_0 collects local model parameters uploaded by NWDAF_1 and NWDAF_2 in FPZ_1, and collects local model parameters uploaded by NWDAF_3 and NWDAF_4 in FPZ_2. The FL-Server calculates a model aggregation weight for FPZ_1 and a model aggregation weight for FPZ_2. The method for calculating the weight is the same as step T4 described in conjunction with FIG. 2(b).

Step S5 is described finally. The FL-Server transmits the aggregated global model to the FL-Client, and the FL-Client performs a new round of training by using the global model as a new local model. Steps S3 to S5 are repeated until a predetermined condition is met. The predetermined condition includes that the global model reaches a predetermined accuracy or a predetermined number of rounds of training is performed.

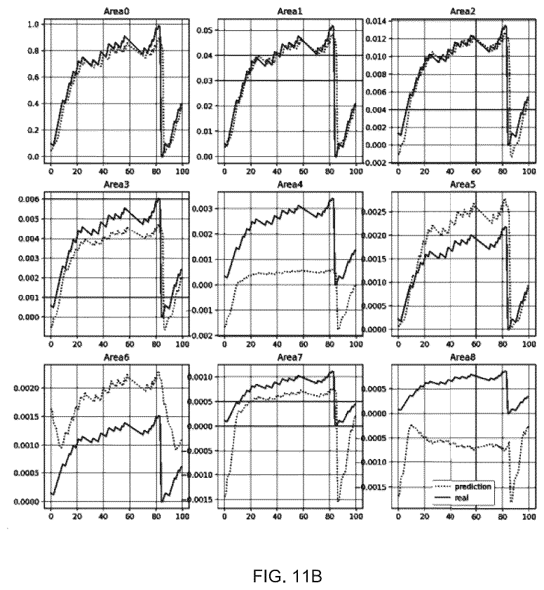

FIG. 10 is an example flow chart of obtaining a primary system behavior model through federated learning based on a federated prediction region according to an embodiment of the present disclosure.

The process starts at step S101. In step S102, federated prediction regions are constructed. In step S103, LSTM models are constructed based on the federated prediction regions. In step S104, local LSTM models are trained by federated learning clients based on based on local data. In step S105, it is determined whether an aggregation period is reached or the model is converged. The process returns to step S104 in a case where a determination result in step S105 is negative. The process proceeds to step S106 in a case where a determination result in step S105 is positive. In step S106, in a case of centralized federated learning, the federated learning clients upload the local models to the federated learning server; and in a case of distributed federated learning, a federated learning client for performing model aggregation collects local models of other federated learning clients. In step S107, it is determined whether collection of local models is completed. The process returns to step S106 in a case where a determination result in step S107 is negative. The process proceeds to step S108 in a case where a determination result in step S107 is positive. In step S108, a model aggregation weight is calculated to aggregate the local models, and the global model is determined as a new local model. In step S109, it is determined whether the number of times of federated aggregation is reached. The process returns to step S104 in a case where a determination result in step S109 is negative. The process proceeds to step S110 in a case where a determination result in step S109 is positive. The process ends at step S110.

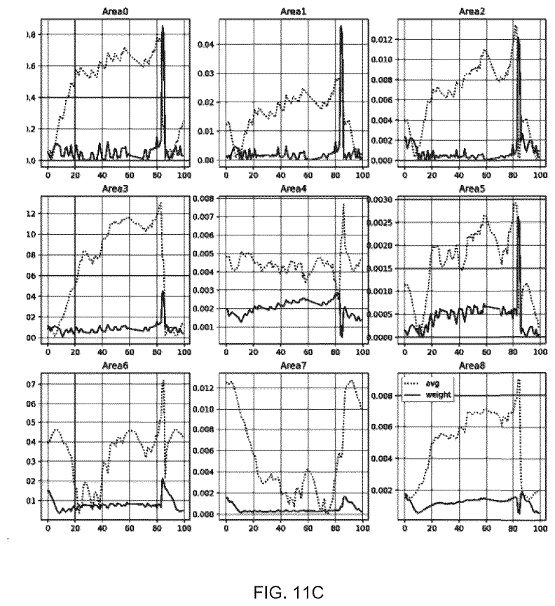

The federated learning model aggregation using weights (for example, weights calculated according to Equation (1)) calculated based on the quantity of geographic units occupied by user devices in the secondary systems associated with the federated learning clients (referred to as quantity-weighted aggregation) can improve an average prediction accuracy of the aggregated model. FIG. 11(a) shows an actual received power of a primary system and a predicted received power of the primary system predicted through a conventional technology, FIG. 11(b) shows an actual received power of a primary system and a predicted received power of the primary system predicted with quantity weighted aggregation, and FIG. 11(c) shows an error of a predicted received power of a primary system predicted through a conventional technology and an error of a predicted received power of the primary system predicted with quantity weighted aggregation. To demonstrate the performance in prediction accuracy, FIG. 11(b) illustrates a predicted power in a case where an input of the LSTM model contains PU signal received powers of 9 minimum cells. In FIG. 11(a) to FIG. 11(c), nine areas, namely Area 0 to Area 8, are involved. In FIG. 11(a) and FIG. 11(b), the horizontal axis represents time, the vertical axis represents a predicted received power of a primary system and an actual received power of the primary system, the power is in a unit of mW, the solid line represents the actual received power (marked with real in the figure), and the dotted line represents the predicted received power (marked with prediction in the figure). FIG. 11(a) shows a prediction effect of a traditional average weighted federated learning algorithm, and FIG. 11(b) shows a prediction effect of prediction using quantity weighted aggregation. It can be seen that FIG. 11(b) shows a better prediction effect, that is, in FIG. 11(b), the predicted received power of the primary system is closer to the actual received power of the primary system. In FIG. 11(c), the vertical axis represents mW, the solid line represents an error curve of prediction using quantity weighted aggregation (marked with weight in the figure), and the dotted line represents an error curve of a traditional average weighted federated learning algorithm (marked with avg in the figure). It can be seen that the prediction using quantity weighted aggregation according to the embodiment of the present disclosure has a smaller error.

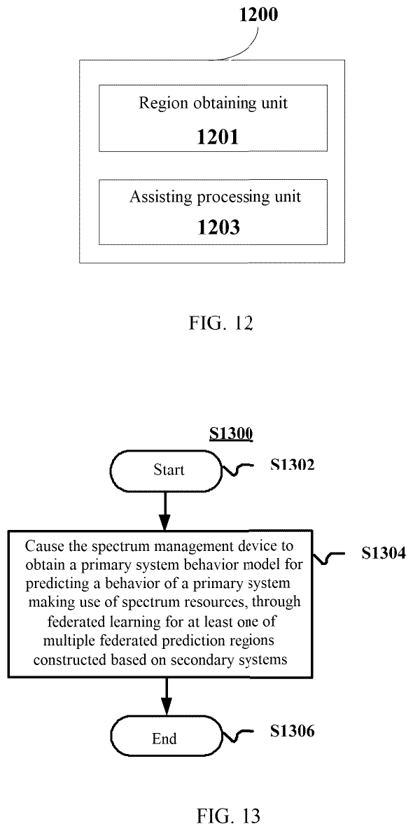

An electronic apparatus for a spectrum management device is further provided according to another embodiment of the present disclosure. FIG. 12 shows a block diagram of functional modules of an electronic apparatus 1200 for a spectrum management device according to another embodiment of the present disclosure.

As shown in FIG. 12, the electronic apparatus 1200 includes a region obtaining unit 1201 and an assisting processing unit 1203. The region obtaining unit 1201 may be configured to obtain one of multiple federated prediction regions constructed based on secondary systems. The assisting processing unit 1203 may be configured to assist in obtaining a primary system behavior model for predicting a behavior of a primary system making use of spectrum resources, through federated learning. It should be understood that various functional units in the electronic apparatus shown in FIG. 12 are only logical modules determined based on specific functions thereof, and are not intended to limit a specific implementation.

The federated prediction region obtaining unit 1201 and the assisting processing unit 1203 may be implemented by one or more processing circuits. The processing circuitry may be implemented as a chip, for example.

The electronic apparatus 1200 may serve as a network-side apparatus in a wireless communication system, and may be specifically provided on a base station side or be communicatively connected to a base station, for example. Here, it should be noted that the electronic apparatus 1200 may be implemented at a chip level or at an apparatus level. For example, the electronic apparatus 1200 may operate as the base station itself and may further include a memory, a transceiver (not shown), and other external devices. The memory may store related data information and programs that the electronic apparatus needs to execute to achieve various functions. The transceiver may include one or more communication interfaces to support communications with different devices (such as a server, a base station, and the like). An implementation of the transceiver is not specifically limited here.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art may understand that the wireless communication system according to the present disclosure may be a 4G or 3G communication system.

In the embodiment of the present disclosure, the electronic apparatus 1200 is able to assist in effectively predicting a received power of a primary system in different regions for spectrum resource sensing.

As an example, the spectrum management device, namely the electronic apparatus 1200 may obtain a trained local primary system behavior model from a corresponding federated learning client that corresponds to the spectrum management device and participates in the federated learning, the corresponding federated learning client pre-processes a data set uploaded from a secondary system associated with the spectrum management device and trains a local primary system behavior model based on the pre-processed data set.

As an example, the corresponding federated learning client is implemented by NWDAF.

As an example, the corresponding federated learning client may be one of NWDAF_1 to NWDAF_4 in FIG. 2(a).

As an example, the pre-processing includes: in a case where multiple primary system signal received powers corresponding to a same geographical unit exists in the data set, averaging the multiple primary system signal received powers, where the geographical unit has a predetermined geographical dimension.

For a description of pre-processing, reference may be made to the description in conjunction with FIG. 2(a), which is not repeated here.

As an example, the corresponding federated learning client transmits the trained local primary system behavior model to a federated learning server participating in the federated learning, for the federated learning server to perform aggregation based on the local primary system behavior model to obtain the primary system behavior model.

As an example, the spectrum management device, namely the electronic apparatus 1200, may serve as a federated learning client participating in the federated learning, and the assisting processing unit 1203 may be configured to pre-processes a data set uploaded from a secondary system associated with the spectrum management device and trains a local primary system behavior model based on the pre-processed data set. In this example, the electronic apparatus 1200 may serve as a federated learning client and participate in the federated learning directly. For example, the electronic device 1200 may directly participate in the federated learning in place of the corresponding NWDAF (for example, one of NWDAF_1 to NWDAF_4) in FIG. 2(a).

As an example, the pre-processing includes: in a case where multiple primary system signal received powers corresponding to a same geographical unit exists in the data set, averaging the multiple primary system signal received powers, where the geographical unit has a predetermined geographical dimension.

For a description of pre-processing, reference may be made to the description in conjunction with FIG. 2(a), which is not repeated here.

As an example, the assisting processing unit 1203 may be configured to transmits the trained local primary system behavior model to a federated learning server participating in the federated learning, for the federated learning server to perform aggregation based on the local primary system behavior model to obtain the primary system behavior model.

In the description of the electronic apparatuses for a spectrum management device in the above embodiments, some processes or methods are further disclosed. Hereinafter, an overview of the methods is given without repeating some of details discussed above. It should be noted that although disclosed in the description of the electronic apparatuses for a spectrum management device, the methods do not necessarily adopt the components as described or be performed by those components. For example, an embodiment of the electronic apparatus for a spectrum management device may be implemented partially or entirely using hardware and/or firmware, while a method for a spectrum management device discussed below may be implemented entirely by a computer-executable program, although the method may employ the hardware and/or firmware for the electronic apparatus for a spectrum management device.

FIG. 13 shows a flow chart of a method S1300 for a spectrum management device according to an embodiment of the present disclosure. The method S1300 starts from step S1302. In step S1304, the spectrum management device is caused to obtain a primary system behavior model for predicting a behavior of a primary system making use of spectrum resources, through federated learning for at least one of multiple federated prediction regions constructed based on secondary systems. The method S1300 ends at step S1306.

This method may be performed, for example, by the electronic apparatus 100 as described above. For specific details, reference may be made to the description of relevant processes of the electronic apparatus 100, which is not repeated here.

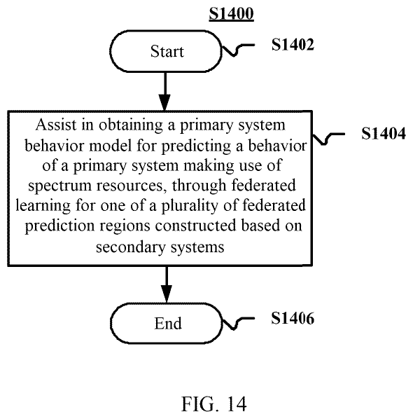

FIG. 14 shows a flow chart of a method S1400 for a spectrum management device according to another embodiment of the present disclosure. The method S1400 starts from step S1402. In step S1404, it is assisted in obtaining a primary system behavior model for predicting a behavior of a primary system making use of spectrum resources, through federated learning for one of a plurality of federated prediction regions constructed based on secondary systems. The method S1400 ends at step S1406.

This method may be performed, for example, by the electronic apparatus 1200 as described above. For specific details, reference may be made to the description of relevant processes of the electronic apparatus 1200, which is not repeated here.

The technology of the present disclosure is applicable to various products.

The electronic apparatus 100 and the electronic apparatus 1200 may be implemented as various network side apparatus. The network side apparatus may be provided on a base station side or be connected to a base station. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. A similar situation may apply to the gNB. Alternatively, the base station may be implemented as any other type of base station, such as a NodeB or a base transceiver station (BTS). The base station may include a body (which is also referred to as a base station device) configured to control wireless communications and one or more remote radio heads (RRHs) arranged at a different place from the body. In addition, various types of electronic apparatuses may operate as base stations by temporarily or semi-persistently performing base station functions.

### Application Examples of Base Station

### First Application Example

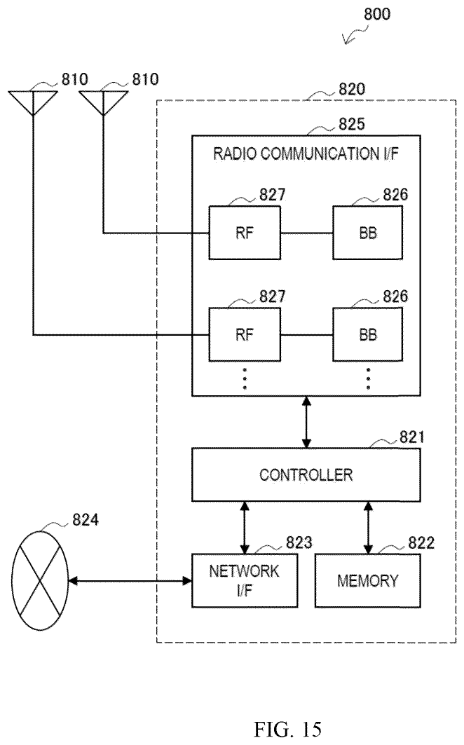

FIG. 15 is a block diagram showing a first example of a schematic configuration of an eNB or gNB to which the technology of the present disclosure is applicable. It should be noted that the following description is made taking an eNB as an example. The technology of the present disclosure is also applicable to a gNB. An eNB 800 includes one or more antennas 810 and a base station device 820. The base station device 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station device 820 to transmit and receive wireless signals. As shown in FIG. 15, the eNB 800 may include multiple antennas 810. For example, the multiple antennas 810 may be compatible with multiple frequency bands used by the eNB 800. Although FIG. 15 shows an example in which the eNB 800 includes multiple antennas 810, the eNB 800 may include a single antenna 810.

The base station device 820 includes a controller 821, a memory 822, a network interface 823, and a radio communication interface 825.

The controller 821 may be, for example, a CPU or DSP, and operates various functions of a higher layer of the base station device 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station device 820 to a core network 824. The controller 821 may communicate with the core network node or another eNB via the network interface 823. In this case, the eNB 800 and the core network node or another eNB may be connected to each other through a logical interface (such as an S1 interface and an X2 interface). The network interface 823 may be a wired communication interface or a radio communication interface for a wireless backhaul line. In a case that the network interface 823 is a radio communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 826 and an RF circuit 827. The BB processor 826 may perform, for example, coding/decoding, modulation/demodulation and multiplexing/de-multiplexing, and perform various types of signal processes of layers (for example, layer 1, media access control (MAC), radio link control (RLC) and packet data convergence protocol (PDCP)). Instead of the controller 821, the BB processor 826 may have a part or all of the above-mentioned logical functions. The BB processor 826 may be a memory storing a communication control program, or a module including a processor and a related circuit configured to execute the program. Updating the program may change the functions of the BB processor 826. The module may be a card or blade inserted into a slot of the base station device 820. Alternatively, the module may be a chip mounted on the card or blade. In addition, the RF circuit 827 may include, for example, a mixer, a filter and an amplifier, and transmit and receive a wireless signal via the antenna 810.

As shown in FIG. 15, the radio communication interface 825 may include multiple BB processors 826. For example, the multiple BB processors 826 may be compatible with multiple frequency bands used by the eNB 800. As shown in FIG. 15, the radio communication interface 825 may include multiple RF circuits 827. For example, the multiple RF circuits 827 may be compatible with multiple antenna elements. Although FIG. 15 shows an example in which the radio communication interface 825 includes multiple BB processors 826 and multiple RF circuits 827, the radio communication interface 825 may include a single BB processor 826 or a single RF circuit 827.

In the eNB 800 as shown in FIG. 15, the electronic apparatuses 100 and 1200, when implemented as base stations, have transceivers that may be implemented by the radio communication interface 825. At least a part of the functions may be implemented by the controller 821. For example, the controller 821 may effectively predict the received power of the primary system in different regions for spectrum resource sensing by executing functions of the units in the electronic apparatus 100 and the electronic apparatus 1200.

### Second Application Example

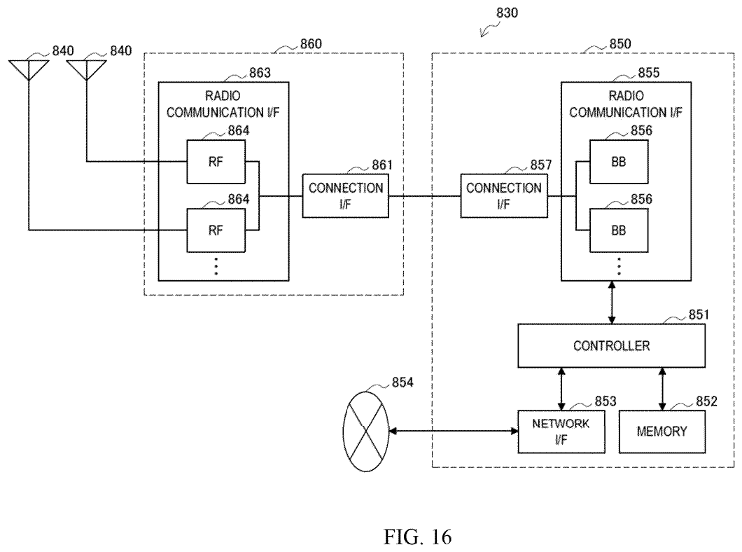

FIG. 16 is a block diagram showing a second example of a schematic configuration of an eNB or gNB to which the technology of the present disclosure is applicable. It should be noted that the following description is made taking the eNB as an example. The technology of the present disclosure is also applicable to the gNB. An eNB 830 includes a single or multiple antennas 840, a base station device 850 and an RRH 860. The RRH 860 and each of the antennas 840 may be connected to each other via an RF cable. The base station device 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 16, the eNB 830 may include multiple antennas 840. For example, the multiple antennas 840 may be compatible with multiple frequency bands used by the eNB 830. Although FIG. 16 shows an example in which the eNB 830 includes multiple antennas 840, the eNB 830 may include a single antenna 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 15.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 826 described with reference to FIG. 15, except that the BB processor 856 is connected to an RF circuit 864 of the RRH 860 via the connection interface 857. As shown in FIG. 16, the radio communication interface 855 may include multiple BB processors 856. For example, the multiple BB processors 856 may be compatible with multiple frequency bands used by the eNB 830. Although FIG. 16 shows an example in which the radio communication interface 855 includes multiple BB processors 856, the radio communication interface 855 may include a single BB processor 856.

The connection interface 857 is an interface for connecting the base station device 850 (the radio communication interface 855) to the RRH 860. The connection interface 857 may be a communication module for communication in the above-described high-speed line that connects the base station device 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station device 850. The connection interface 861 may be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 16, the radio communication interface 863 may include multiple RF circuits 864. For example, the multiple RF circuits 864 may support multiple antenna elements. Although FIG. 16 shows an example in which the radio communication interface 863 includes multiple RF circuits 864, the radio communication interface 863 may include a single RF circuit 864.

In the eNB 830 as shown in FIG. 16, the electronic apparatuses 100 and 1200, when implemented as base stations, have transceivers that may be implemented by the radio communication interface 855. At least a part of the functions may be implemented by the controller 851. For example, the controller 851 may effectively predict the received power of the primary system in different regions for spectrum resource sensing by executing functions of the units in the electronic apparatus 100 and the electronic apparatus 1200.

### Application Example of User Equipment

### First Application Example

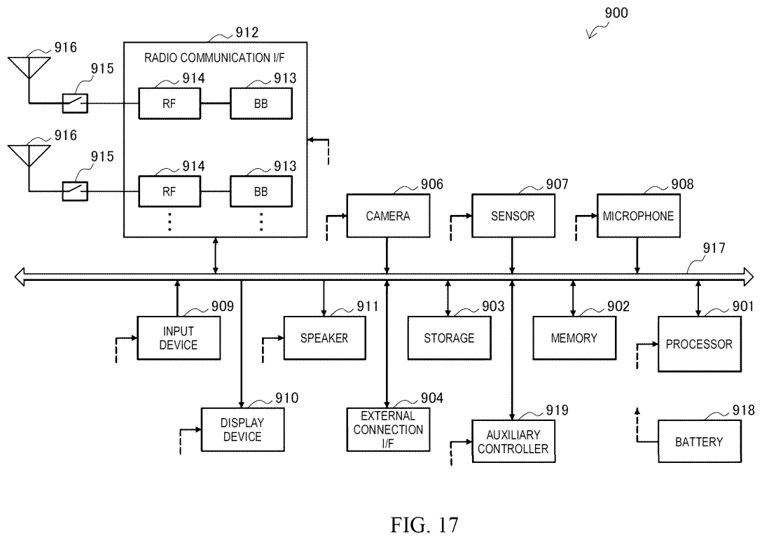

FIG. 17 is a block diagram showing an example of a schematic configuration of a smart phone 900 to which the technology of the present disclosure is applicable. The smart phone 900 includes a processor 901, a memory 902, a storage device 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on chip (SoC), and controls functions of the application layer and other layers of the smart phone 900. The memory 902 includes an RAM and an ROM, and stores data and programs executed by the processor 901. The storage device 903 may include a storage medium, such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter and an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 17, the radio communication interface 912 may include multiple BB processors 913 and multiple RF circuits 914. Although FIG. 17 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 17, the smart phone 900 may include multiple antennas 916. Although FIG. 17 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage device 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 17 via a feeder line. The feeder line is partially shown as a dashed line in the figure. The auxiliary controller 919 operates the least necessary function of the smart phone 900 in a sleep mode, for example.

In the smart phone 900 as shown in FIG. 17, the transceiver may be implemented through the radio communication interface 912. At least part of the functions may be implemented by the processor 901 or the auxiliary controller 919.

### Second Application Example

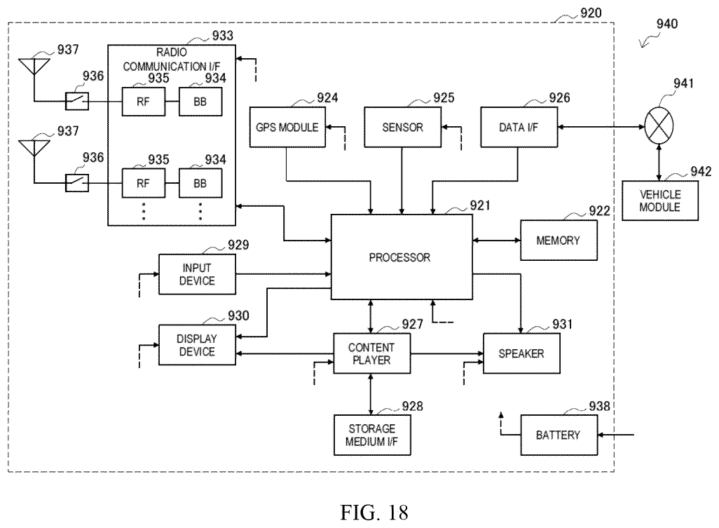

FIG. 18 is a block diagram showing an example of a schematic configuration of an automobile navigation device 920 to which the technology of the present disclosure is applicable. The automobile navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or SoC, and controls the navigation function and other functions of the automobile navigation device 920. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 926 is connected to, for example, an in-vehicle network 941 via a terminal not shown, and acquires data (such as vehicle speed data) generated by a vehicle.

The content player 927 reproduces content stored in a storage medium (such as a CD and a DVD) inserted into the storage medium interface 928. The input device 929 includes, for example, a touch sensor configured to detect a touch on a screen of the display device 930, a button, or a switch, and receives an operation or information inputted from a user. The display device 930 includes a screen such as an LCD or OLED display, and displays an image or reproduced content of a navigation function. The speaker 931 outputs a sound or reproduced content of the navigation function.

The radio communication interface 933 supports any cellular communication scheme (such as LTE and LTE-Advanced), and performs wireless communications. The radio communication interface 933 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter and an amplifier, and transmit and receive a wireless signal via the antenna 937. The radio communication interface 933 may be a chip module on which the BB processor 934 and the RF circuit 935 are integrated. As shown in FIG. 18, the radio communication interface 933 may include multiple BB processors 934 and multiple RF circuits 935. Although FIG. 18 shows an example in which the radio communication interface 933 includes multiple BB processors 934 and multiple RF circuits 935, the radio communication interface 933 may include a single BB processor 934 or a single RF circuit 935.

In addition to the cellular communication scheme, the radio communication interface 933 may support another type of wireless communication scheme, such as a short-range wireless communication scheme, a near field communication scheme, or a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 933.

Each of the antennas 937 includes a single or multiple antenna elements (such as multiple antenna elements included in a MIMO antenna), and is configured for the radio communication interface 933 to transmit and receive wireless signals. As shown in FIG. 18, the automobile navigation device 920 may include multiple antennas 937. Although FIG. 18 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 18 via a feeder line. The feeder line is partially shown as a dashed line in the figure. The battery 938 accumulates electric power supplied from the vehicle.

In the vehicle navigation device 920 as shown in FIG. 18, the transceiver may be implemented through the radio communication interface 933. At least part of the functions may be implemented by the processor 921.

The technology of the present disclosure may be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with the specific embodiments. However, it should be noted that those skilled in the art can understand that all or any of steps or components of the methods and apparatuses of the present disclosure may be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the method according to any of the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

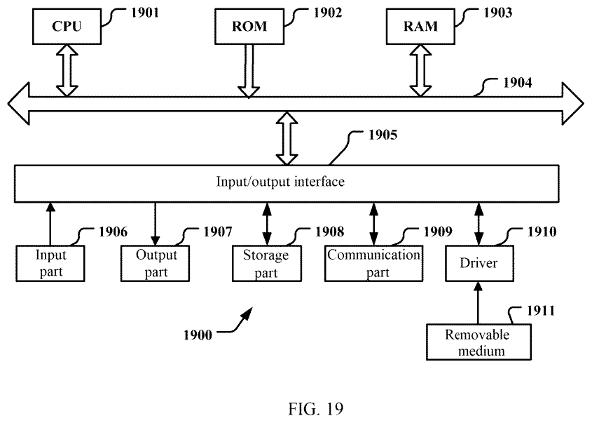

In a case of implementing the embodiments of the present disclosure in software or firmware, the program consisting of the software is mounted to a computer with a dedicated hardware structure (such as a general-purpose computer 1900 as shown in FIG. 19) from the storage medium or network. The computer, when mounted with various programs, performs various functions.

In FIG. 19, a central processing unit (CPU) 1901 executes various processes according to a program stored in a read-only memory (ROM) 1902 or a program loaded from a storage part 1908 to a random-access memory (RAM) 1903. In the RAM 1903, data required for the CPU 1901 to perform various processes or the like is stored as necessary. The CPU 1901, the ROM 1902 and the RAM 1903 are connected to each other via a bus 1904. An input/output interface 1905 is connected to the bus 1904.

The following components are connected to the input/output interface 1905: an input part 1906 (including a keyboard, a mouse, and the like), an output part 1907 (including a display, such as a cathode ray tube (CRT) and a liquid crystal display (LCD), a loudspeaker, and the like), a storage part 1908 (including a hard disk and the like), and a communication part 1909 (including a network interface card, such as a LAN card, and a modem). The communication part 1909 performs communication processing via a network, such as the Internet. A driver 1910 may be connected to the input/output interface 1905 as needed. A removable medium 1911, such as a magnetic disk, an optical disk, a magnetic optical disk, and a semiconductor memory, is mounted to the driver 1910 as required, so that a computer program read therefrom is mounted to the storage part 1908 as required.

In a case that the above processes are implemented by software, the program consisting the software is mounted from a network, such as the Internet, or from a storage medium, such as the removable medium 1911.

Those skilled in the art should understood that, the storage medium is not limited to the removable medium 1911, as shown in FIG. 19, which stores a program and is distributed separately from the device so as to provide the program for a user. Examples of the removable medium 1911 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1902, the hard disk contained in the storage part 1908, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) σ(n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.

Solution 1. An electronic apparatus for a spectrum management device, comprising processing circuitry configured to:
obtain a primary system behavior model for predicting a behavior of a primary system making use of spectrum resources, through federated learning for at least one of a plurality of federated prediction regions constructed based on secondary systems.

Solution 2. The electronic apparatus according to solution 1, wherein
the plurality of federated prediction regions are constructed based on geographical location of the secondary systems, and
a size of the federated prediction region is reflected by a quantity of geographic units having a predetermined geographical dimension.

Solution 3. The electronic apparatus according to solution 2, wherein a quantity and locations of the federated prediction regions are determined through a k-means algorithm and a density-based spatial clustering algorithm DBSCAN for noisy applications.

Solution 4. The electronic apparatus according to solution 3, wherein
the k-means algorithm is applied to cluster base stations in the secondary systems, delete a cluster containing no base station without changing location of a cluster center, and set location of a specific base station in a cluster as a new cluster center in a case where a distance between the specific base station and a center of the cluster to which the specific base station belongs exceeds a first predetermined distance threshold,
the DBSCAN algorithm is applied to input locations of cluster centers determined through the k-means algorithm to obtain new cluster centers, and merge cluster centers whose distances are less than a second predetermined distance threshold among the new cluster centers, and
the k-means algorithm and the DBSCAN algorithm are repeated until a quantity of cluster centers no longer changes, wherein the cluster centers serve as centers of federated prediction regions and the quantity of the cluster centers corresponds to the quantity of the plurality of federated prediction regions.

Solution 5. The electronic apparatus according to any one of solutions 2 to 4, wherein a lower limit of sizes of the plurality of federated prediction regions is determined based on a distance between a center of a federated prediction region and a secondary system, and each federated prediction region is updated and determined based on accuracy and/or energy consumption when a primary system behavior model converges.

Solution 6. The electronic apparatus according to any one of solutions 1 to 5, wherein the primary system behavior model is a multi-input-multi-output long-short term memory neural network model.

Solution 7. The electronic apparatus according to solution 6, wherein a dimension of input and output of the multi-input multi-output long-short term memory neural network model is determined by a size of a federated prediction region.

Solution 8. The electronic apparatus according to solution 7, wherein for each federated prediction region, an input of the multi-input-multi-output long-short term memory neural network model is information of primary system signal received power of all geographical units in the federated prediction region in a predetermined number of historical time slots, and an output of the multi-input-multi-output long-short term memory neural network model is a predicted value of a primary system signal received power of each geographical unit in a next time slot.

Solution 9. The electronic apparatus according to any one of solutions 1 to 8, wherein the primary system behavior model is obtained by aggregating local primary system behavior models obtained from federated learning clients participating in the federated learning.

Solution 10. The electronic apparatus according to solution 9, wherein local primary system behavior models corresponding to the federated learning clients are aggregated by calculating weights based on the quantity of geographical units occupied by user equipment in secondary systems associated with the federated learning clients.

Solution 11. The electronic apparatus according to solution 9, wherein local primary system behavior models corresponding to the federated learning clients are aggregated by calculating weights based on a distribution status of user equipment in secondary systems associated with the federated learning clients.

Solution 12. The electronic apparatus according to solution 9, wherein local primary system behavior models are aggregated by calculating weights based on a model accuracy of the local primary system behavior models corresponding to the federated learning clients.

Solution 13. The electronic apparatus according to solution 12, wherein a model accuracy of a local primary system behavior model increases as a user data volume involved in the local primary system behavior model increases, and decreases as a loss of the local primary system behavior model increases.

Solution 14. The electronic apparatus according to any one of solutions 9 to 13, wherein as a loss of the local primary system behavior model decreases monotonically, a period of the aggregation decreases monotonically.

Solution 15. The electronic apparatus according to solution 14, wherein in a case where a loss of the local primary system behavior model does not monotonically decrease, a period of the aggregation is reduced according to a predetermined proportion.

Solution 16. The electronic apparatus according to any one of solutions 1 to 15, wherein the spectrum management device serves as a federated learning server, and the processing circuitry is configured to: determine, as the primary system behavior model, a final global model obtained by aggregating local primary system behavior models trained by one or more other spectrum management devices serving as respective federated learning clients participating in the federated learning.

Solution 17. The electronic apparatus according to solution 16, wherein the processing circuitry is configured to transmit a federated learning request to other spectrum management devices within a federated prediction region associated with the electronic apparatus, and receive a federated learning response from other spectrum management devices that agree to participate in the federated learning.

Solution 18. The electronic apparatus according to solution 17, wherein the federated learning response comprises the quantity of geographical units occupied by user equipment in secondary systems associated with the federated learning clients.

Solution 19. The electronic apparatus according to any one of solutions 16 to 18, wherein the processing circuitry is configured to:
in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and
stop the federated learning after a predetermined condition is met, and determine a final global model obtained as the primary system behavior model.

Solution 20. The electronic apparatus according to solution 19, wherein the predetermined condition comprises that the final global model reaches a predetermined accuracy and/or a predetermined number of rounds of training is performed.

Solution 21. The electronic apparatus according to any one of solutions 1 to 15, wherein the spectrum management device determines a final global model obtained from a federated learning server as the primary system behavior model, wherein the federated learning server aggregates local primary system behavior models trained by respective federated learning clients participating in the federated learning, to obtain the final global model.

Solution 22. The electronic apparatus according to solution 21, wherein the federated learning server transmits a federated learning request to other devices within a federated prediction region associated with the federated learning server, and receives a federated learning response from other devices that agree to participate in the federated learning.

Solution 23. The electronic apparatus according to solution 22, wherein the federated learning response comprises the quantity of geographical units occupied by user equipment in secondary systems associated with the federated learning clients.

Solution 24. The electronic apparatus according to any one of solutions 21 to 23, wherein the federated learning server is configured to:
in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and
stop the federated learning after a predetermined condition is met, and obtain the final global model.

Solution 25. The electronic apparatus according to solution 24, wherein the predetermined condition comprises that the final global model reaches a predetermined accuracy and/or a predetermined number of rounds of training is performed.

Solution 26. The electronic apparatus according to any one of solutions 21 to 25, wherein the federated learning server is implemented by a network data analytics function NWDAE

Solution 27. The electronic apparatus according to any one of solutions 1 to 15, wherein the spectrum management device serves as a federated learning client, and the processing circuitry is configured to: perform the federated learning in conjunction with one or more other spectrum management devices serving as federated learning clients; and determine, as the primary system behavior model, a global model obtained by aggregating local primary system behavior models trained by respective federated learning clients.

Solution 28. The electronic apparatus according to solution 27, wherein the processing circuitry is configured to transmit, to other federated learning clients, the quantity of geographical units occupied by user equipment in the secondary systems associated with the spectrum management device.

Solution 29. The electronic apparatus according to solution 27 or 28, wherein the processing circuitry is configured to
aggregate, based on weights, the local primary system behavior models trained by the spectrum management device and local primary system behavior models received from other federated learning clients through broadcasting, in each round of training of the federated learning to obtain a global model, and use the global model as a new local primary system behavior model for a next round of training; and
stop the federated learning after a predetermined condition is met, and determine a final global model obtained as the primary system behavior model.

Solution 30. The electronic apparatus according to solution 27 or 28, wherein the spectrum management device is selected to perform the aggregation when the following predetermined condition is satisfied:
based on channel information between the spectrum management device and the one or more other spectrum management devices, calculating a sum of transmission energy consumptions of transmission paths between the spectrum management device and the one or more other spectrum management devices in a case where the spectrum management device serves as an aggregation device for aggregating local primary user behavior models within federated prediction regions associated with the spectrum management device,
where a sum of transmission energy consumptions in a case where the spectrum management device serves as an aggregation device is less than a sum of transmission energy consumptions in a case where any one of the one or more other spectrum management devices serves as the aggregation device.

Solution 31. The electronic apparatus according to solution 30, wherein the processing circuitry is configured to exchange the channel information with the one or more other spectrum management devices via broadcasting.

Solution 32. The electronic apparatus according to solution 30 or 31, wherein the transmission energy consumption of a transmission path is calculated based on a transmission rate and transmission power of the transmission path.

Solution 33. The electronic apparatus according to any one of solutions 27 to 33, wherein the spectrum management device is implemented by a base station in a secondary system or an edge server associated with a secondary system.

Solution 34. An electronic apparatus for a spectrum management device, comprising
processing circuitry configured to:
assist in obtaining a primary system behavior model for predicting a behavior of a primary system making use of spectrum resources, through federated learning for one of a plurality of federated prediction regions constructed based on secondary systems.

Solution 35. The electronic apparatus according to solution 34, wherein
the spectrum management device serves as a federated learning client participating in the federated learning,
the processing circuitry is configured to pre-process a data set uploaded from a secondary system associated with the spectrum management device and train a local primary system behavior model based on the pre-processed data set.

Solution 36. The electronic apparatus according to solution 35, wherein the pre-processing comprises: in a case where a plurality of primary system signal received powers corresponding to a same geographical unit exists in the data set, averaging the plurality of primary system signal received powers, wherein the geographical unit has a predetermined geographical dimension.

Solution 37. The electronic apparatus according to solution 35 or 36, wherein the processing circuitry is configured to transmit the trained local primary system behavior models to a federated learning server participating in the federated learning, for the federated learning server to perform aggregation based on the local primary system behavior models to obtain the primary system behavior model.

Solution 38. The electronic apparatus according to solution 34, wherein
the spectrum management device obtains a trained local primary system behavior model from a corresponding federated learning client that corresponds to the spectrum management device and participates in the federated learning,
the corresponding federated learning client pre-processes a data set uploaded from a secondary system associated with the spectrum management device and trains a local primary system behavior model based on the pre-processed data set.

Solution 39. The electronic apparatus according to solution 38, wherein the pre-processing comprises: in a case where a plurality of primary system signal received powers corresponding to a same geographical unit exists in the data set, averaging the plurality of primary system signal received powers, wherein the geographical unit has a predetermined geographical dimension.

Solution 40. The electronic apparatus according to solution 38 or 39, wherein the corresponding federated learning client transmits the trained local primary system behavior model to a federated learning server participating in the federated learning, for the federated learning server to perform aggregation based on the local primary system behavior model to obtain the primary system behavior model.

Solution 41. The electronic apparatus according to any one of solutions 38 to 40, wherein the corresponding federated learning client is implemented by a network data analytics function NWDAF.

Solution 42. A method for a spectrum management device, comprising:
causing the spectrum management device to obtain a primary system behavior model for predicting a behavior of a primary system making use of spectrum resources, through federated learning for at least one of a plurality of federated prediction regions constructed based on secondary systems.

Solution 43. A method for a spectrum management device, comprising:
assisting in obtaining a primary system behavior model for predicting a behavior of a primary system making use of spectrum resources, through federated learning for one of a plurality of federated prediction regions constructed based on secondary systems.

Solution 44. A computer-readable storage medium, storing computer executable instructions, wherein the computer executable instructions, when executed by a processor, cause the process to perform the method for a spectrum management device according to any one of solutions 42 to 43.

1. An electronic apparatus for a spectrum management device, comprising processing circuitry configured to:
obtain a primary system behavior model for predicting a behavior of a primary system making use of spectrum resources, through federated learning for at least one of a plurality of federated prediction regions constructed based on secondary systems.

2. The electronic apparatus according to claim 1, wherein
the plurality of federated prediction regions are constructed based on geographical location of the secondary systems, and
a size of the federated prediction region is reflected by a quantity of geographic units having a predetermined geographical dimension.

3. The electronic apparatus according to claim 2, wherein a quantity and locations of the federated prediction regions are determined through a k-means algorithm and a density-based spatial clustering algorithm DBSCAN for noisy applications.

4. The electronic apparatus according to claim 3, wherein
the k-means algorithm is applied to cluster base stations in the secondary systems, delete a cluster containing no base station without changing location of a cluster center, and set location of a specific base station in a cluster as a new cluster center in a case where a distance between the specific base station and a center of the cluster to which the specific base station belongs exceeds a first predetermined distance threshold,
the DBSCAN algorithm is applied to input locations of cluster centers determined through the k-means algorithm to obtain new cluster centers, and merge cluster centers whose distances are less than a second predetermined distance threshold among the new cluster centers, and
the k-means algorithm and the DBSCAN algorithm are repeated until a quantity of cluster centers no longer changes, wherein the cluster centers serve as centers of federated prediction regions and the quantity of the cluster centers corresponds to the quantity of the plurality of federated prediction regions.

5. The electronic apparatus according to claim 2, wherein a lower limit of sizes of the plurality of federated prediction regions is determined based on a distance between a center of a federated prediction region and a secondary system, and each federated prediction region is updated and determined based on accuracy and/or energy consumption when a primary system behavior model converges.

6. The electronic apparatus according to claim 1, wherein the primary system behavior model is a multi-input-multi-output long-short term memory neural network model.

7. The electronic apparatus according to claim 6, wherein a dimension of input and output of the multi-input multi-output long-short term memory neural network model is determined by a size of a federated prediction region.

8. The electronic apparatus according to claim 7, wherein for each federated prediction region, an input of the multi-input-multi-output long-short term memory neural network model is information of primary system signal received power of all geographical units in the federated prediction region in a predetermined number of historical time slots, and an output of the multi-input-multi-output long-short term memory neural network model is a predicted value of a primary system signal received power of each geographical unit in a next time slot.

9. The electronic apparatus according to claim 1, wherein the primary system behavior model is obtained by aggregating local primary system behavior models obtained from federated learning clients participating in the federated learning.

10. electronic apparatus according to claim 9, wherein local primary system behavior models corresponding to the federated learning clients are aggregated by calculating weights based on the quantity of geographical units occupied by user equipment in secondary systems associated with the federated learning clients.

11. The electronic apparatus according to claim 9, wherein local primary system behavior models corresponding to the federated learning clients are aggregated by calculating weights based on a distribution status of user equipment in secondary systems associated with the federated learning clients.

12. electronic apparatus according to claim 9, wherein local primary system behavior models are aggregated by calculating weights based on a model accuracy of the local primary system behavior models corresponding to the federated learning clients.

13. The electronic apparatus according to claim 12, wherein a model accuracy of a local primary system behavior model increases as a user data volume involved in the local primary system behavior model increases, and decreases as a loss of the local primary system behavior model increases.

14. The electronic apparatus according to claim 9, wherein as a loss of the local primary system behavior model decreases monotonically, a period of the aggregation decreases monotonically.

15. The electronic apparatus according to claim 14, wherein in a case where a loss of the local primary system behavior model does not monotonically decrease, a period of the aggregation is reduced according to a predetermined proportion.

16. The electronic apparatus according to claim 1, wherein the spectrum management device serves as a federated learning server, and
the processing circuitry is configured to: determine, as the primary system behavior model, a final global model obtained by aggregating local primary system behavior models trained by one or more other spectrum management devices serving as respective federated learning clients participating in the federated learning.

17. The electronic apparatus according to claim 16, wherein the processing circuitry is configured to transmit a federated learning request to other spectrum management devices within a federated prediction region associated with the electronic apparatus, and receive a federated learning response from other spectrum management devices that agree to participate in the federated learning.

18. The electronic apparatus according to claim 17, wherein the federated learning response comprises the quantity of geographical units occupied by user equipment in secondary systems associated with the federated learning clients.

19. The electronic apparatus according to claim 16, wherein the processing circuitry is configured to:
in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and
stop the federated learning after a predetermined condition is met, and determine a final global model obtained as the primary system behavior model.

20. The electronic apparatus according to claim 19, wherein the predetermined condition comprises that the final global model reaches a predetermined accuracy and/or a predetermined number of rounds of training is performed.

21. The electronic apparatus according to claim 1, wherein
the spectrum management device determines a final global model obtained from a federated learning server as the primary system behavior model, wherein
the federated learning server aggregates local primary system behavior models trained by respective federated learning clients participating in the federated learning, to obtain the final global model.

22. The electronic apparatus according to claim 21, wherein the federated learning server transmits a federated learning request to other devices within a federated prediction region associated with the federated learning server, and receives a federated learning response from other devices that agree to participate in the federated learning.

23. The electronic apparatus according to claim 22, wherein the federated learning response comprises the quantity of geographical units occupied by user equipment in secondary systems associated with the federated learning clients.

24. The electronic apparatus according to claim 21, wherein the federated learning server is configured to:
in each round of training of the federated learning, aggregate the local primary system behavior models trained by respective federated learning clients based on weights to obtain a global model, and transmit the global model to respective federated learning clients, for the respective federated learning clients to perform a next round of training based on the global model; and
stop the federated learning after a predetermined condition is met, and obtain the final global model.

25. The electronic apparatus according to claim 24, wherein the predetermined condition comprises that the final global model reaches a predetermined accuracy and/or a predetermined number of rounds of training is performed.

26. The electronic apparatus according to claim 21, wherein the federated learning server is implemented by a network data analytics function NWDAF.

27. The electronic apparatus according to claim 1, wherein the spectrum management device serves as a federated learning client, and
the processing circuitry is configured to: perform the federated learning in conjunction with one or more other spectrum management devices serving as federated learning clients; and determine, as the primary system behavior model, a global model obtained by aggregating local primary system behavior models trained by respective federated learning clients.

28. The electronic apparatus according to claim 27, wherein the processing circuitry is configured to transmit, to other federated learning clients, the quantity of geographical units occupied by user equipment in the secondary systems associated with the spectrum management device.

29. The electronic apparatus according to claim 27, wherein the processing circuitry is configured to
aggregate, based on weights, the local primary system behavior models trained by the spectrum management device and local primary system behavior models received from other federated learning clients through broadcasting, in each round of training of the federated learning to obtain a global model, and use the global model as a new local primary system behavior model for a next round of training; and
stop the federated learning after a predetermined condition is met, and determine a final global model obtained as the primary system behavior model.

30. The electronic apparatus according to claim 27, wherein the spectrum management device is selected to perform the aggregation when the following predetermined condition is satisfied:
based on channel information between the spectrum management device and the one or more other spectrum management devices, calculating a sum of transmission energy consumptions of transmission paths between the spectrum management device and the one or more other spectrum management devices in a case where the spectrum management device serves as an aggregation device for aggregating local primary user behavior models within federated prediction regions associated with the spectrum management device,
where a sum of transmission energy consumptions in a case where the spectrum management device serves as an aggregation device is less than a sum of transmission energy consumptions in a case where any one of the one or more other spectrum management devices serves as the aggregation device.

31. The electronic apparatus according to claim 30, wherein the processing circuitry is configured to exchange the channel information with the one or more other spectrum management devices via broadcasting.

32. The electronic apparatus according to claim 30, wherein the transmission energy consumption of a transmission path is calculated based on a transmission rate and transmission power of the transmission path.

33. The electronic apparatus according to claim 27, wherein the spectrum management device is implemented by a base station in a secondary system or an edge server associated with a secondary system.

34. An electronic apparatus for a spectrum management device, comprising
processing circuitry configured to:
assist in obtaining a primary system behavior model for predicting a behavior of a primary system making use of spectrum resources, through federated learning for one of a plurality of federated prediction regions constructed based on secondary systems.

35. The electronic apparatus according to claim 34, wherein
the spectrum management device serves as a federated learning client participating in the federated learning,
the processing circuitry is configured to pre-process a data set uploaded from a secondary system associated with the spectrum management device and train a local primary system behavior model based on the pre-processed data set.

36. The electronic apparatus according to claim 35, wherein the pre-processing comprises: in a case where a plurality of primary system signal received powers corresponding to a same geographical unit exists in the data set, averaging the plurality of primary system signal received powers, wherein the geographical unit has a predetermined geographical dimension.

37. The electronic apparatus according to claim 35, wherein the processing circuitry is configured to transmit the trained local primary system behavior models to a federated learning server participating in the federated learning, for the federated learning server to perform aggregation based on the local primary system behavior models to obtain the primary system behavior model.

38. The electronic apparatus according to claim 34, wherein
the spectrum management device obtains a trained local primary system behavior model from a corresponding federated learning client that corresponds to the spectrum management device and participates in the federated learning,
the corresponding federated learning client pre-processes a data set uploaded from a secondary system associated with the spectrum management device and trains a local primary system behavior model based on the pre-processed data set.

39. The electronic apparatus according to claim 38, wherein the pre-processing comprises: in a case where a plurality of primary system signal received powers corresponding to a same geographical unit exists in the data set, averaging the plurality of primary system signal received powers, wherein the geographical unit has a predetermined geographical dimension.

40. The electronic apparatus according to claim 38, wherein the corresponding federated learning client transmits the trained local primary system behavior model to a federated learning server participating in the federated learning, for the federated learning server to perform aggregation based on the local primary system behavior model to obtain the primary system behavior model.

41. The electronic apparatus according to claim 38, wherein the corresponding federated learning client is implemented by a network data analytics function NWDAF.

42. A method for a spectrum management device, comprising:
causing the spectrum management device to obtain a primary system behavior model for predicting a behavior of a primary system making use of spectrum resources, through federated learning for at least one of a plurality of federated prediction regions constructed based on secondary systems.

43. A method for a spectrum management device, comprising:
assisting in obtaining a primary system behavior model for predicting a behavior of a primary system making use of spectrum resources, through federated learning for one of a plurality of federated prediction regions constructed based on secondary systems.

44. A computer-readable storage medium, storing computer executable instructions, wherein the computer executable instructions, when executed by a processor, cause the process to perform the method for a spectrum management device according to claim 42.
